(19) United States
(12) Patent Application Publication
(10) Pub. No.: US 2024/0391713 A1
(43) Pub. Date: Nov. 28, 2024

(54) LOADING DOCK SYSTEMS FOR DETECTING TRAILER DOOR STATUS AND/OR TRAILER CARGO STATUS AND ASSOCIATED METHODS OF MANUFACTURE AND USE

(71) Applicants: Richard K. Hoofard, Dallas, TX (US); Daryl Day, Frisco, TX (US)

(72) Inventors: Richard K. Hoofard, Dallas, TX (US); Daryl Day, Frisco, TX (US)

(21) Appl. No.: 18/324,770

(22) Filed: May 26, 2023

(51) Int. Cl. B65G 69/28; B65G 69/00

(52) U.S. Cl. CPC B65G 69/2882; B65G 69/003; B65G 69/2864

(57) ABSTRACT

Loading dock systems for detecting trailer door status and/or trailer cargo status and operating loading dock equipment accordingly are disclosed herein. In some embodiments, a loading dock station can include one or more sensors for detecting whether a trailer door is in an open or closed position, and/or whether trailer cargo is loaded in an end load condition, when the trailer is present at the loading dock station. Sensor targets containing, e.g., QR codes, barcodes, and other machine-readable indicia, etc., as well as reflective targets, can be positioned on trailer doors and/or in trailer cargo areas to facilitate detection and acquisition of related door and/or cargo information. In some embodiments, the systems disclosed herein can activate a sequence of automated dock operations in response to determining the status of the trailer doors and/or the trailer cargo.

### TECHNICAL FIELD

The present disclosure is generally directed to systems and associated methods for detecting information about a trailer at a loading dock, including, e.g., information regarding the status of trailer doors and/or trailer cargo, and performing one or more loading dock operations in response to the information.

### BACKGROUND

Over the road (OTR) trailers (such as, for example, 53 ft. long dry goods trailers) typically include one of two different rear door configurations. One configuration is commonly referred to as a barn door configuration and has two doors, hinged on outer sides, that swing inwardly and outwardly and meet and latch in the middle along the trailer centerline. The other configuration is a roll up door that typically consists of a counterbalanced sectional door that moves upwardly and downwardly along on opposing tracks located at the rear of the trailer. Both door systems are typically opened and closed by either the truck driver or a dock worker when the truck is at a loading dock for loading and/or unloading cargo.

Most loading docks typically include a dock door that can be used to close off an elevated opening into the warehouse or other building at which the loading dock is located. Dock doors are typically of the roll up, sectional type, and consist of a set of individual door panels that extend horizontally and are pivotally connected. By way of example only, in some instances these panels can be 24 inches tall and of the un-insulated sheet metal type, or of the insulated type that can range in thickness from about 0.50 inch to about 4 inches.

### BRIEF DESCRIPTION OF THE DRAWINGS

FIG. 1 is a partially cross-sectional side view of a rear portion of a trailer parked at a loading dock station having a sensor system configured in accordance with embodiments of the present technology.

FIG. 2 is an interior view of the loading dock station of FIG. 1 configured in accordance with embodiments of the present technology.

FIG. 3 is an enlarged cross-sectional view taken along line A-A in FIG. 2 and illustrating a sensor mounted in a door panel in accordance with embodiments of the present technology.

FIG. 4 is an exterior isometric view of a rear portion of a trailer having an informational target positioned on a trailer door in accordance with embodiments of the present technology.

FIGS. 5A and 5B are exterior, rear isometric views of a rear portion of a trailer having one or more informational targets positioned within an interior portion of the trailer in accordance with embodiments of the present technology.

FIG. 6 is a block diagram of a trailer door/trailer cargo detection system configured in accordance with embodiments of the present technology.

FIG. 7 is a flow diagram of a routine for operating a loading dock trailer door and/or trailer cargo detection system in accordance with embodiments of the present technology.

FIGS. 8A and 8B are flow diagrams of routines for operating a loading dock trailer door detection system in accordance with embodiments of the present technology.

FIG. 9 is a flow diagram of a routine for operating a loading dock trailer door and/or trailer space detection system in accordance with embodiments of the present technology.

### DETAILED DESCRIPTION

The following disclosure describes various embodiments of systems and associated methods for determining the status of a door or doors on a cargo trailer, and/or for determining positional or other information associated with cargo in the trailer, at a loading dock. In both manual and automated loading dock environments, it can be desirable to reduce the amount of human interaction with loading dock equipment and reduce human involvement in the cargo loading/unloading processes. In such environments, it can be advantageous to determine whether the trailer door or doors are open prior to arrival of the trailer at the loading dock, and/or whether the cargo is, for example, positioned at or very near the aft end of the trailer (e.g., in an “end load” condition”). Some advantages can include, for example, confirming that the trailer is ready for loading/unloading prior to initiation of an automated dock process (e.g., engaging a trailer restraint, opening a dock door, deploying a dock leveler, etc.). Determining that the trailer is ready for loading/unloading in this manner can prevent wasting time and resources by, for example, engaging a trailer that is not ready for loading or unloading, opening a dock door in an environmentally secure facility, etc., and then having to release the trailer, move the trailer away from the loading dock so that the trailer doors can be opened, and then having to restart the dock process.

In some embodiments, the loading dock systems described herein can include sensors, scanners, reading devices, and/or imaging devices, etc., and associated hardware and/or software that can detect, for example, whether a trailer door is in an open or closed position. This information can then be used as input to an associated control system to control operation of loading dock equipment (e.g., a trailer restraint, a loading dock door, and/or a dock leveler, etc.) based on the status of the trailer door. In some embodiments, the systems described herein can include sensors, scanners, reading devices, and/or imaging devices, etc., and associated hardware and/or software configured to obtain information associated with cargo within the trailer. For example, in some embodiments such scanning, reading and/or imaging devices can obtain this information from an informational target (e.g., a machine-readable code, symbol and/or other indicia) that is displayed within the cargo trailer, and/or from images or 3 dimensional (3D) mappings of the cargo arrangement in the trailer. The cargo information can include, for example, the position or arrangement of the cargo (relative to, e.g., the end of the trailer), the type of cargo (e.g., its contents, source, destination, palleted, stacked, box vs drum, etc.), and/or other information.

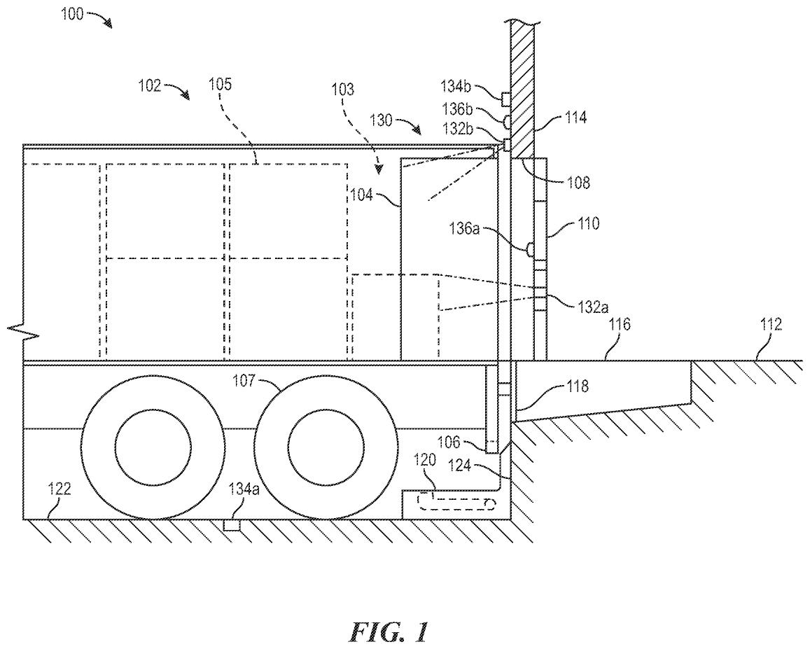

Certain details are set forth in the following description and in FIGS. 1-9 to provide a thorough understanding of various embodiments of the present technology. In other instances, well-known structures, materials, operations and/or systems often associated with shipping trailers (e.g., OTR trailers), loading docks, loading dock equipment, sensor systems, scanning systems, cameras and other imaging devices, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the present technology. Accordingly, other embodiments can have other details, dimensions, angles and features without departing from the spirit or scope of the present disclosure. In addition, those of ordinary skill in the art will appreciate that further embodiments of the present technology can be practiced without several of the details described below. In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a partially cross-sectional side view of an aft end portion of a trailer 102 parked at a loading dock 100 having a sensor system 130 configured in accordance with embodiments of the present technology. The trailer 102 is parked in front of an elevated opening 108 in a wall 114 of the loading dock 100 (which may also be referred to herein as a dock station 100) in a suitable position for cargo unloading and/or loading operations. For example, a rear bumper of the trailer 102 can be positioned against, or at least very close to, one or more bumpers or other similar structures on a dock face 124 to ensure that the trailer 102 is close enough to the dock opening 108 for safe unloading/loading operations. Although not shown, in some embodiments the loading dock 100 can also include a dock seal/shelter (e.g., a compressible seal) on the outside of the dock wall 114 that forms an environmental seal between the dock wall 114 and the aft end of the trailer 102. In some embodiments, the trailer 102 can be a conventional OTR trailer (having a length of, e.g., 28 ft., 45 ft., 48 ft., 53 ft., and/or other dimensions), and in other embodiments the trailer 102 can be other types of shipping trailers, shipping containers, cargo truck compartments, etc. known in the art. Accordingly, it will be appreciated that embodiments of the systems and methods disclosed herein are not limited to any particular type of trailer, truck, and/or trailer/truck door configuration unless the context clearly requires otherwise.

In the illustrated embodiment, the trailer 102 includes a rear impact guard (RIG) bar 106 (also known as an “ICC” bar or “rear underride guard”) which extends downwardly from the rear portion of the trailer 102 and includes a horizontal member configured to be engaged by a vehicle restraint 120 in a conventional manner. The vehicle restraint 120 can be positioned on a parking pad 122 and/or mounted to the dock face 124 directly below the door opening 108. The vehicle restraint 120 can include a mechanical hook or other engagement structure configured to deploy (e.g., upwardly) from a stored position in response to a control input and engage the RIG bar 106 in a conventional manner. This restrains the trailer 102 against or at least directly adjacent to the loading dock 100 and prevents the trailer 102 from moving away from the loading dock 100 during loading and/or unloading operations. The trailer restraint 120 is further configured to retract or otherwise disengage from the RIG bar 106 in response to a corresponding control input and release the trailer 102 after the loading/unloading operations so that the trailer 102 can depart the loading dock 100. In other embodiments, the loading dock 100 can include wheel chocks and/or other suitable forms of manual and/or powered trailer restraints in addition to, or in place of, the vehicle restraint 120.

In addition to the RIG bar 106, in the illustrated embodiment the trailer 102 also includes first and second trailer doors 104 on opposite sides of the trailer 102. In the illustrated embodiment, the trailer doors 104 are of the “barn door” configuration and are supported on hinges that extend vertically on opposite rear edges of the trailer 102. In FIG. 1, only the left side trailer door 104 is shown but it will be understood that a corresponding right side door 104 exists on the other side of the trailer 102. The doors 104 can rotate outwardly to the open position shown in FIG. 1 and inwardly to close and be latched together in a conventional manner. Although barn door type trailer doors are shown in FIG. 1 for purposes of illustration, it should be understood that the various systems and methods described herein can also be used with other types of trailer doors, including roll up trailer door systems comprised of, e.g., multiple panels that can be moved upwardly along opposing sidetracks into a stowed position toward the upper wall of the trailer 102, as well as other types of trailer doors known in the art. Accordingly, the present disclosure and the embodiments of the systems and methods described herein are not limited to use with any particular type of trailer door or doors unless the context clearly requires otherwise.

In the illustrated embodiment, the loading dock 100 includes a dock door 110 that is movable between the closed position shown in FIG. 1 and an open or raised position that provides access for personnel and equipment (e.g., a forklift) to move into and out of a trailer cargo area 103 via the opening 108 for loading and/or unloading of cargo. The loading dock 100 can also include a dock leveler 116 which is movably mounted to a dock floor 112 adjacent to the door opening 108. In some embodiments, the dock leveler 116 can be a conventional horizontally stored or pit dock leveler as shown in FIG. 1, and in other embodiments the dock leveler 116 can be a conventional vertically stored dock leveler and/or other types of suitable dock levelers known in the art. In the illustrated embodiment, the dock leveler 116 includes a lip 118 pivotally mounted to a distal edge portion thereof. When the dock door 110 is in the open position, the dock leveler 116 can be rotated upwardly about a rearward hinge from the stored position shown in FIG. 1 to an elevated position sufficient for the lip 118 to be rotated outwardly toward the door opening 108. Then the dock leveler 116 can be rotated downwardly until the extended lip 118 extends into the trailer cargo area 103 and comes to rest on the trailer floor to facilitate the loading and/or unloading of cargo in a conventional manner.

In one aspect of the present technology, the sensor system 130 includes one or more sensors 132 (identified individually as a first sensor 132a and a second sensor 132b) mounted to the dock door 110, to adjacent surfaces of the dock wall 114, and/or to other structures (e.g., a stand or other fixture (not shown)) positioned proximate (e.g., within 6 inches-8 ft., within 1 ft.-6 ft., or within 1 ft.-4 ft.) of the dock door 110 on, e.g., the parking pad 122. As described in greater detail below, in various embodiments the one or more sensors 132 can be configured to detect, e.g., the trailer door 104, trailer cargo 105, an informational target on the exterior of the trailer door 104, and/or one or more informational targets within the trailer cargo area 103. This information can be used by the sensor system 130 and/or an associated processor to determine, e.g., trailer door status (e.g., whether the trailer doors 104 are in an open or closed position), the position of the cargo 105 relative to, e.g., the rear end of the cargo area 103 (e.g., the rearward edge of the trailer bed), and/or other information regarding the trailer 102, the cargo 105, etc. Once the status of the trailer doors 104 and/or the cargo 105 is known, an automated dock process can be initiated accordingly.

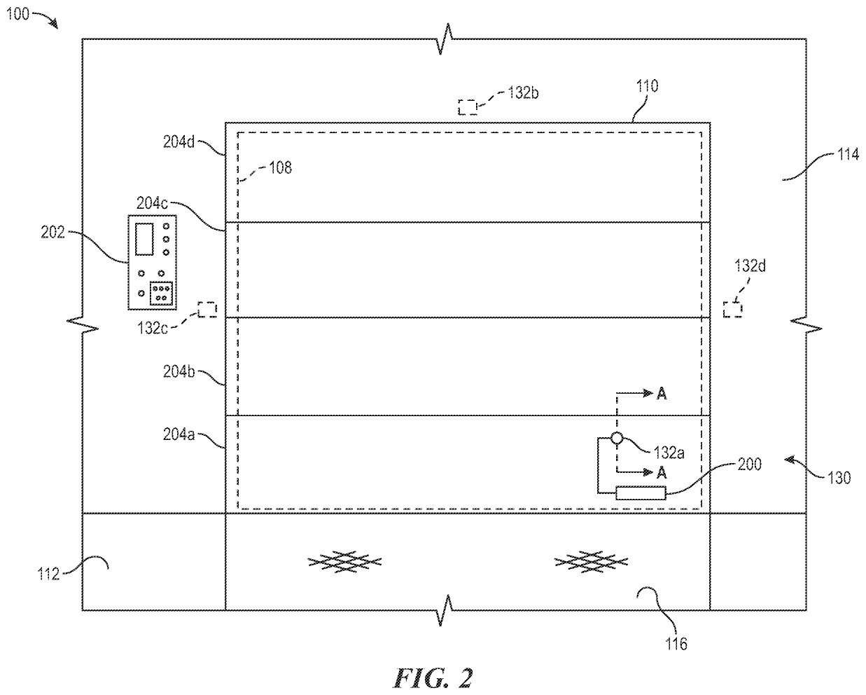

For example, in some embodiments the first sensor 132a can be mounted to the dock door 110 in a perpendicular orientation relative to the outer vertical surface of the dock door 110 and directed outwardly such that the sensor field of view or line of sight is directed at the aft end of the trailer 102 when the trailer 102 is positioned in front of the loading dock opening 108; for example, when the aft end of the trailer 102 is positioned directly in front of the loading dock opening 108 (e.g., against the dock face) and/or when the trailer 102 is positioned in front of the dock opening 108 but spaced apart from the dock face (e.g., when the trailer 102 is backing up to the dock face). In some embodiments, the second sensor 132b can be mounted to the dock wall 114 above (e.g., directly above) the dock door opening 108 and oriented so that the field of view/line of sight of the sensor 132b is directed toward the aft end of the trailer 102 as the trailer 102 approaches the dock door opening 108 and/or is positioned at the opening 108. In some embodiments, the second sensor 132b can be provided at the loading dock 100 instead of the first sensor 132a, and in other embodiments the second sensor 132b can be provided in addition to the first sensor 132a. As described in greater detail below with reference to FIG. 2, in some embodiments the loading dock 100 can include one or more additional sensors mounted to, for example, the dock wall 114 adjacent to the left and/or right-side vertical edges of the dock door opening 108. Such sensors can be provided together with the first sensor 132a and/or the second sensor 132b, or as an alternative to the first sensor 132a and/or the second sensor 132b, and such sensors can be directed toward the aft end of the trailer 102 and oriented so that the sensor field of view/line of sight is directed toward the aft end of the trailer 102 as the trailer 102 approaches the dock door opening 108 and/or is positioned at the opening 108.

In some embodiments, the sensors 132 can include position/distance sensors, scanners/readers (e.g., quick response (QR) code scanners/readers, barcode scanners/readers, radio frequency identification (RFID) readers, and other scanners/readers capable of detecting and interpreting, e.g., machine-readable indicia), 3D scanners and mapping devices (e.g., light detection and ranging (LiDAR) scanners), cameras and other imaging devices, etc. For example, in some embodiments the sensors 132 can be electro-optical photoelectric sensors capable of determining ranges or distances between the sensor and sensed objects (e.g., the trailer door 104), such as a Banner S18-2VPDL-Q8 photoelectric sensor or a Banner brand QS30LV beam sensor, both available from Banner Engineering Corp., 9714 Tenth Avenue North, Minneapolis, MN 55441, USA. In some embodiments, the sensors 132 can also include time of flight (TOF) sensors (e.g., laser or LED based TOF sensors) capable of determining ranges or distances between the sensor and sensed objects, and/or LiDAR sensors or similar types of sensors, cameras, etc. for, e.g., 3D mapping and imaging of objects to determine, e.g., placement of objects, size of objects, orientation of objects, etc. By way of example only, such LiDAR sensors can include multiScan100 3D LiDAR sensors from SICK, of 6900 W 110th St., Minneapolis, MN, 55438 USA. The sensors 132 can further include, for example, high sensitivity radar sensors using frequency modulated continuous wave (FMCW) radar for detection of moving or stationary targets, etc., 3D LiDAR scanners, 3D TOF sensors, etc. In some embodiments, the sensors can include QR code scanners, barcode scanners, and/or other devices configured to detect and read, QR codes, barcodes, and/or other machine-readable indicia. In other embodiments, the sensors 132 can also include optic sensors, ultrasonic sensors, infrared sensors, cameras (e.g., machine vision cameras, etc.) and other imaging devices, etc. Embodiments of the sensors 132 including cameras and similar imaging devices can include machine vision cameras, camera systems utilizing visual recognition software, optical character recognition (OCR) software, etc. It is expected that virtually any type of sensor suitable for determining, e.g., the presence and/or location of sensed objects; distances between the sensor and sensed objects; information from a target, visual marking and/or machine-readable code or indicia; information regarding the identity, size, shape, arrangement and/or contents of an object; etc., can be used with various embodiments of the present technology. Accordingly, it will be understood that embodiments of the present technology are not limited to any particular type of sensor, scanner, reader, imaging device, etc. unless the particular context in which the sensor is described requires otherwise.

As described in greater detail below, in some embodiments the trailer 102 can include a first target mounted to or otherwise positioned on one of the trailer doors 104, and/or a second target positioned within the cargo area 103. The first target can include a code (e.g., a QR code, barcode, etc.) or other indicia that, for example, contains or conveys information or data about the trailer door or doors 104, the trailer 102, the trailer cargo 105, etc., and the second target can include a code or other indicia that, for example, contains or conveys information or data regarding the arrangement or position of the cargo 105 relative to, e.g., the aft edge of the cargo area 103, the source of the cargo 105, the contents of the cargo 105, etc. By way of example only, the targets can include QR codes, barcodes, other machine-readable indicia, or a combination of codes, symbols, etc. that provide, e.g., identification information, positional information, content information, source/destination information, etc. In some embodiments, the targets can include passive or active devices, such as passive or active RFID transponders (tags) that provide such information and/or data. In other embodiments, the targets can be visual/optical targets (e.g., reflective targets) that can be used to determine, e.g., spatial information (e.g., distance and positional information) associated with the target. In some embodiments, the first target can include a first visual pattern, such as a striped, yellow/black pattern, and the second target can include a second, dissimilar pattern, such as spots or the like. Regardless of the form of the targets, the sensors 132a and/or 132b can be configured to detect and read or otherwise interpret the information provided by the targets. In other embodiments, the targets can be omitted, and the one or more sensors 132a-d at the loading dock 100 can be configured to detect any object (e.g., the trailer door 104, the cargo 105, etc.) in their line of sight and this information can be used to determine, e.g., the trailer door status and/or trailer cargo status, etc.

In some embodiments, the loading dock 100 can further include one or more lights 136 or other illumination devices (identified individually as a first light 136a and a second light 136b) mounted to the dock door 110 and/or an adjacent exterior surface of the dock wall 114. The lights 136 can illuminate the aft end of the trailer 102 as the trailer 102 approaches the dock 100 and/or the low light region between the aft end of the trailer 102 and the dock door 110 when the trailer 102 is in the position shown in FIG. 1. In some embodiments, the illumination can ensure that the one or more sensors 132a and 132b can sufficiently detect the status of the trailer doors 104, read targets on the trailer door 104 and/or the cargo 105, etc.

As noted above, the sensor or sensors 132a and 132b can be mounted in various locations that are advantageously selected for sensing trailer door status (open/closed) and/or whether the trailer cargo 105 is in an end load condition. A trailer end load condition is one in which the trailer 102 is loaded to the extreme aft end of the internal cargo area 103, or at least close enough to the aft end of the cargo area 103 that the dock leveler lip 118 cannot be properly installed on the trailer bed. This condition typically requires that the first layer of the cargo 105 (e.g., the cargo 105 at the extreme end of the cargo area 103) be removed from the trailer 102 prior to placement of the dock leveler lip 118 onto the trailer bed.

In some embodiments, the sensors 132a and 132b can be in a powered-down state until a truck presence sensor (TPS) 134 indicates the presence of the trailer 102 at the loading dock 100. In some embodiments, a first TPS 134a can positioned on the parking pad 122 in front of the loading dock 100, and in other embodiments a second TPS 134b can be mounted on, e.g., an exterior surface of the loading dock wall 114, the dock door 110, or in any other suitable location. The TPSs 134a and 134b can include any type of suitable sensor including, for example, an ultrasonic sensor, an optical sensor, an electromagnetic sensor, a contact sensor, a radar sensor, photocell, and/or essentially any sensor capable of detecting the presence of the trailer 102 on the parking pad 122 in front of the loading dock 100. In yet other embodiments, the sensor system 130 described herein can be alerted to the presence of the trailer 102 by an outside entity in addition to, or instead of, being alerted by the TPSs 134a or 134b. For example, in some embodiments the sensor system 130 can be powered on in response to an input signal from an associated yard or logistics management system, via a signal from the incoming tractor/trailer, and/or other means.

FIG. 2 is an interior view of the docking station 100 configured in accordance with embodiments of the present technology. In the illustrated embodiment, the dock door 110 is a sectional door configured to move upwardly and away from the dock opening 108 on opposing guide tracks in a conventional manner. The dock door 110 can include a plurality of hingedly connected door panels 204 (identified individually as door panels 204a-d). In the illustrated embodiment, the first sensor 132a is mounted in the lower or first door panel 204a. In other embodiments, the sensor 132a can be positioned in other of the door panels 204, as well as on the exterior surface of the dock wall 114 adjacent to the left or right sides of the dock opening 108 (see, e.g., the second and third sensors 132c and 132d) and/or directly above the door opening 108 (see, e.g., the second sensor 132b).

In the illustrated embodiment, the sensor system 130 further includes a sensor controller 200. In some embodiments, the sensor controller 200 includes a power source (e.g., a battery), a communication device, and an associated processor for operation of the first sensor 132a as described herein. The communication device can include a wireless transceiver for wireless communication between, for example, the sensor controller 200 and a dock control panel 202, and/or between the sensor controller 200 and other devices (e.g., trailer communication systems (e.g., driver operated devices), central dock management systems, enterprise resource planning (ERP) systems, web interfaces, etc.) In other embodiments, the sensor 132a may be wired to the control panel 202 and/or to other dock management systems. Such embodiments may be most suitable for the sensors 132b-d which are positioned on the dock wall 114 and are therefore not movable with the dock door 110. In other embodiments, the sensor 132a can have a self-contained power source and communication capability, and in such embodiments it is contemplated that the separate sensor controller 200 may be omitted.

In some embodiments, the sensor controller 200 can be mounted directly to the door panel 204a and operably connected to the sensor 132a via a wired connection or suitable wireless connection, and in other embodiments the controller 200 can be mounted in other suitable locations proximate the sensor 132a (e.g., to an interior surface of the wall 114, etc.). Although not shown in FIG. 2, it will be understood that although the sensor controller 200 has been described with reference to the first sensor 132a, in some embodiments the sensors 132b-c can also be connected to the same or similar controllers for suitable operation of the sensors as described herein.

In a further aspect of this embodiment, the dock control panel 202 (which may also be referred to as a digital master control panel (DMCP)) can include a human-machine interface (HMI) having various user interface features and devices (e.g., knobs, buttons, touchscreen, indicator lights, etc.) so that a user (e.g., dock operator) can control operation of the various loading dock equipment present at the docking station 100 (e.g., the vehicle restraint 120, the dock door 110, the dock leveler 116, etc.) in a conventional manner, as well as obtain information regarding the status of cargo trailers and other vehicles present at the dock, and/or other information related to dock operations. It will be understood that, although in some embodiments of the present technology the control panel 202 may be configured to receive manual user input for control of the associated loading dock equipment, in some embodiments the loading dock 100 described herein is configured for automated, or at least partially automated, dock operations that do not require operator control inputs. Similarly, it will also be understood that one or more of the steps, processes and/or control inputs described herein as being automated may, in some embodiments, be performed manually by a dock operated via, e.g., the control panel 202

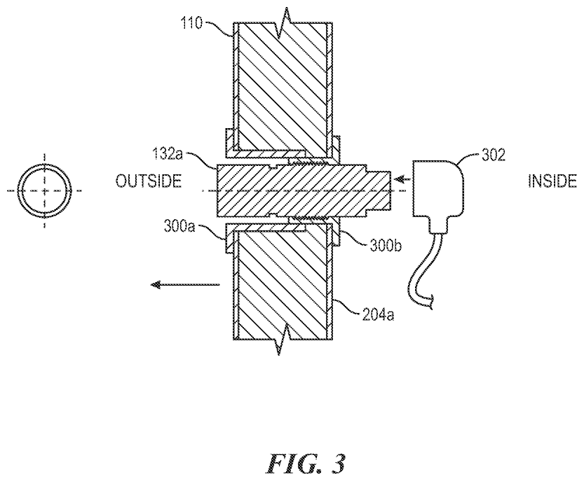

FIG. 3 is an enlarged side cross-sectional view taken along line A-A in FIG. 2 and illustrating one arrangement for mounting the sensor 132a to the panel 204a of the dock door 110 in accordance with embodiments of the present technology. In the illustrated embodiment, the door panels 204 are insulated door panels having an internal core material sandwiched between metal face sheets (e.g., aluminum sheets). The door panels 104 can vary in thickness from, e.g., 0.5 inch to 4 inches or more. As discussed above, in some embodiments the sensor 132a can be mounted on the door panel 204a in a perpendicular orientation with respect to the plane of the door 110 and positioned so that the field of view and/or the operative line of sight of the sensor 132a will include the aft end of the trailer 102 (e.g., the trailer doors 104 and/or the interior of the cargo area 103; FIG. 1). In other embodiments, the sensor 132a can have other orientations relative to the plane of the dock door 110 but still be oriented so that the field of view/line of sight will include the aft end of the trailer 102. For example, in other embodiments the sensor 132a can be positioned such that the line of sight extends parallel to a horizontal plane but at a non-perpendicular angle relative to the door 110, or the line of sight can extend at a non-perpendicular angle relative to both the horizontal and vertical planes.

In the embodiment of FIG. 3, the sensor 132a extends through an aperture in the door panel 204a (e.g., a circular hole that can be drilled or otherwise formed in the door panel 204a) and can be held in place by a bracket or other suitable fixture comprised of a first flanged sensor fitting 300a and a second flanged sensor fitting 300b. In some embodiments, the sensor fittings 300a,b can be configured to threadably or otherwise concentrically engage to secure the sensor 132a and the door panel 204a. In other embodiments, the sensor 132a and/or the other sensors described herein can be mounted to the door panel 204a and/or other door panels, dock walls, etc. using other suitable mounting systems including other brackets, fixtures, adhesives, magnets, etc. In the illustrated embodiment, the sensor 132a includes a receptacle on an aft end portion thereof configured to receive a connector 302 (e.g., an electrical connector) for operably connecting the sensor 132a to the sensor controller 200 (FIG. 2) via a wired connection.

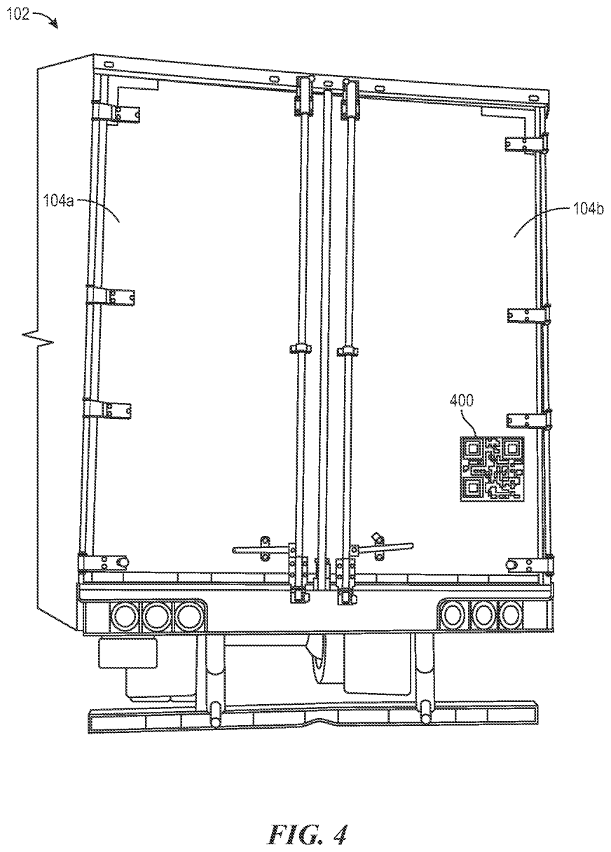

FIG. 4 is a rear view of the trailer 102 having a target 400 affixed to the trailer door 104b in accordance with embodiments of the present technology. In the illustrated embodiment, the target 400 includes a QR code. In other embodiments, however, the target 400 can include a barcode or other machine-readable indicia, text (which, for example, can be read via optical character recognition (OCR)), and/or any other graphics, markings, symbology, or other visual or non-visual representations that can be detected, identified and/or read by a sensor. In some embodiments, the target 400 can include a QR code or other machine-readable indicia that, when read, provides information (e.g., in the form of a number, text, etc.) identifying it as being a target mounted to a trailer door (e.g., the door 104 on the trailer 102). In other embodiments, the target 400, when read, can provide information about the trailer 102, the contents of the cargo 105, the position of the cargo 105 relative to the aft end of the trailer bed, etc. The target 400 can be appropriately sized for optimum, or at least suitable, reading at the desired distance from a selected sensor (e.g., the first sensor 132a; FIG. 1). For example, if the target 400 is a QR code and the ideal scanning size to distance ratio is 10:1, then the target 400 can be 1 ft. by 1 ft. in size, or at least approximately this size, if the sensor 132a is configured to read the target 400 at a distance of 10 ft. In other embodiments, the target 400 can have other sizes depending on the type of target, the desired detection/reading distance, etc. Additionally, although the target 400 has been described above as an informational target that can include, e.g., a scannable/readable code or other indicia, in other embodiments the target 400 and various embodiments thereof can include passive reflective targets and/or other types of targets, such as TOF sensor targets.

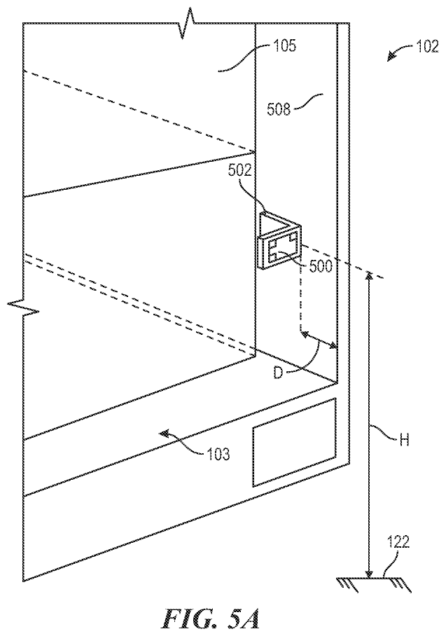

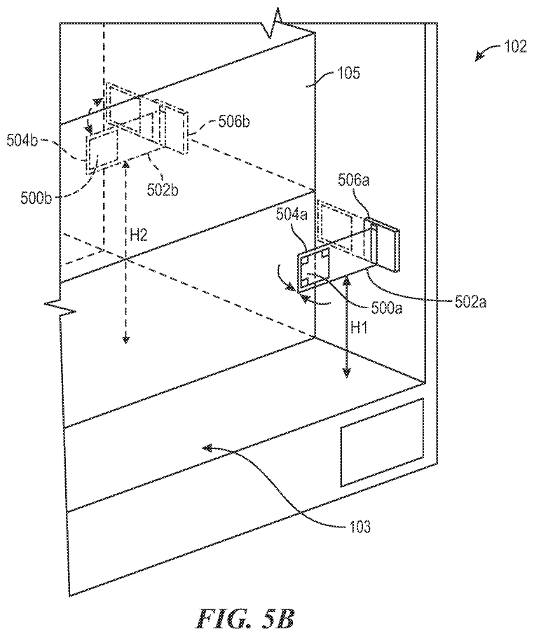

FIGS. 5A and 5B are rear isometric views of the trailer 102 with the trailer doors 104 in the open position to expose the interior cargo area 103. Referring first to FIG. 5A, in the illustrated embodiment the trailer 102 includes a target 500 positioned on a support structure 502 (e.g., a bracket) which is in turn attached to an interior side wall 508 of the trailer 102. In this embodiment, the target 500 is oriented perpendicular to, or at least approximately perpendicular to, the side wall 508 and faces outwardly through the aft opening of the trailer 102 so that it can be “seen” or otherwise detected by one or more of the sensors 132 described in detail above as the trailer 102 approaches the dock station 100 and/or after the trailer 102 is parked at the dock station 100. As discussed above, in some embodiments the target 500 can include a QR code or other machine-readable indicia that, when read, provides information identifying it as being a target mounted within the cargo area 103 of the trailer 102. In other embodiments, the target 500 can provide information about, e.g., the contents of the cargo 105, the source of the cargo 105, the position of the cargo 105 relative to the aft end of the trailer bed, special unloading requirements, etc.

In some embodiments, the target 500 can be positioned at a location in the trailer 102 whereby detection of the target by a sensor outside the trailer 102 (e.g., one or more of the sensors 132a-d) indicates that the cargo 105 is not in an end load condition (that is, that the cargo 105 is not positioned so close to the aft edge of the cargo area 103 that it would interfere with deployment of the dock leveler lip 118 onto the trailer bed). For example, the target 500 can be positioned a distance D from the aft edge of the cargo area 103, and the distance D can be selected to ensure that, if the cargo 105 is positioned further forward in the trailer 102 than the target 500 (i.e., further away from the aft edge of the cargo area 103 than the target 500), the cargo 105 will not interfere with the dock leveler lip 118 as the lip 118 is being deployed onto the trailer bed. Conversely, if the cargo 105 is positioned further aft in the trailer 102 than the target 500 (i.e., closer to the aft edge of the cargo area 103 than the target 500), then the dock leveler lip 118 will, or at least could, strike the cargo 105 as the lip 118 is being deployed onto the trailer bed. Accordingly, if the target 500 is not detectable by the sensor, this can be an indication that the target 500 was not installed because the cargo 105 is positioned so close to the aft edge of the cargo area 103 that it would have interfered with the target 500 and thus prevented the target 500 from being installed or otherwise deployed from the trailer wall 508. Thus, the inability to detect the target 500 by the sensor can be an indication that the cargo 105 is in an end load condition and, consequently, the dock leveler lip 118 should not be deployed into the trailer 102. By way of example, in some embodiments the distance D can be from 1 inch to 48 inches, from about 4 inches to 36 inches, from 8 inches to 24 inches, from 8 inches to 16 inches, or about 12 inches.

In some embodiments, the target 500 can be positioned at a height H above the parking pad 122. By way of example, the height H can be from 36 inches to 96 inches, from 48 inches to 84 inches, from 48 inches to 72 inches, or about 63 inches. In some embodiments, the dimensions H and D are examples of dimensions by which a normal height driver/yard worker can access the target 500 when opening/closing the trailer doors 104 (FIG. 4). Additionally, the distance D can be selected so that the target 500 is far enough away from the aft edge of the trailer 102 so that the dock leveler lip 118 will not strike the target 500 as the lip 118 is being deployed onto or retracted from the trailer bed. In some embodiments, this is the distance extending inward from the rear edge of the trailer 102 that is required for the dock leveler lip 118 to set on the trailer bed without issue during loading and unloading operations. In other embodiments, the target 500 can be located in other orientations and/or positions relative to, for example, the parking pad 122 and/or the aft edge of the trailer 102.

Referring next to FIG. 5B, in the illustrated embodiment the trailer 102 includes a first target 500a positioned on a first support structure 502a having an arm 504a (e.g., a pivotable or foldable arm) movably coupled to a base 506a which is mounted to the side wall 508 of the trailer 102. In some embodiments, the proximal end portion of the arm 504a is pivotally received by the base 506a and can include detents that receive, e.g., spring-loaded balls, pins, etc. that can selectively lock the arm 504a in both a deployed position (e.g., a position in which the arm 504a extends orthogonally to the side wall 508 as shown in FIG. 5B) and a stowed position in which the arm 504a lays against (e.g., flat against), or at least approximately against, the side wall 508 either in front of or aft of the base 506a (as shown by the phantom lines in FIG. 5B). In other embodiments, the arm 504a can be pivotally mounted to the base 506a and include other mechanical, electrical, and/or magnetic features to selectively lock the arm in both the deployed and stowed positions. Although in some embodiments the arm 504a described above may be manually moved between the deployed and stowed positions, in other embodiments the cargo target 500a can be mounted on a self-deploying arm or hinge whereby, for example, when the trailer door (e.g., the trailer door 104b; FIG. 4) is opened, the arm automatically moves from the stowed position to the deployed position, and when the trailer door is closed, the arm automatically retracts to the stowed position. In yet other embodiments, the cargo target 500a can be positioned on an arm or other support structure (e.g., a spring-loaded structure) that has a fixed base but is resilient and flexible such that it can deflect toward the stowed position upon impact with, e.g., cargo, personnel, equipment, etc. but return to the deployed position when the external force is removed. Use of a pivotable or foldable support arm 504a as described herein can enable the target 500a to be retracted and stowed for movement of the cargo 105 into and/or out of the trailer 102, and/or for placement of the cargo 105 in the cargo area 103 directly adjacent to the base 506a. That is, for placement of the cargo 105 in the portion of the cargo area 103 that would otherwise have been occupied by the arm 504a and the target 500a had the target 500a been deployed. As discussed above in reference to the target 500 of FIG. 5A, in some embodiments the target 500a can be positioned in the trailer 102 at a location whereby detection of the target by a sensor outside the trailer 102 (e.g., one or more of the sensors 132a-d) indicates that the cargo 105 is not in an end load condition.

In some embodiments, the trailer 102 can include two or more targets in the cargo area 103. For example, in addition to the first target 500a, the trailer 102 can also include a second target 500b positioned further forward in the cargo area 103 than the first target 500a (i.e., further away from the aft opening in the trailer 102). The second target 500b can be mounted to or otherwise positioned on a second support structure 502b that is at least generally similar in structure and function to the first support structure 502a. In some embodiments, it can be advantageous to provide two or more targets in the trailer 102 because of the additional information that can be provided by an additional one or more targets. For example, if a sensor (e.g., the first sensor 132a) detects the first target 500a as the trailer 102 approaches the loading dock 100 or when the trailer 102 is parked at the loading dock 100, the sensor system 130 (FIG. 1) can ascertain or otherwise determine from the detection of the first target 500a that the cargo 105 is not in an end load condition, but the system will not be able to determine from this information how far forward of the target 500a the cargo 105 is placed in the cargo area 103. However, if the trailer 102 includes the second target 500b at, for example, the midpoint between the forward and aft ends of the cargo area 103, and the sensor is able to detect the second target 500b, this indicates that the second target support structure 502b is deployed (i.e., not in the stowed position to provide clearance for adjacent cargo 105), which in turn can be interpreted to indicate that the cargo 105 is positioned forward of the second target 500b. Similarly, in some embodiments the trailer 102 can include a target (e.g., a third target 500c; not shown) positioned on or near to the forward wall of the trailer 102 (i.e., the wall opposite the doors 104), and detection of this target by the sensor can indicate that the trailer 102 is empty, or at least substantially empty of cargo 105. To enable the first sensor 132a and/or the other sensors 132b-d (FIGS. 1 and 2) to detect the first target 500a and the second target 500b, the targets can be positioned so that the first target 500a does not block the second sensor 500b relative to the line of sight of the sensor or sensors. For example, in some embodiments the first sensor can be positioned at a first height H1 above the trailer floor and the second sensor 500b can be positioned at a second height H2, that is greater than H1, above the trailer floor.

Accordingly, in some embodiments the trailer 102 can include a single target 500, and in other embodiments the trailer 102 can include two or more targets 500, such as a second target halfway down the length of the trailer 102, and/or a third target positioned on or at least proximate the forward wall of the trailer. Any one of the sensor targets 500 discussed above can be provided alone or in various combinations with other sensor targets 500. In other embodiments, trailers and other cargo compartments can include other numbers of sensor targets in other arrangements. Additionally, although the targets 500 have been described above as informational targets that can include, e.g., a scannable/readable code or other indicia, in other embodiments the targets 500 can include passive reflective targets and/or other types of targets, such as TOF sensor targets. As discussed above, in some embodiments the targets 500 can be omitted and one or more of the dock-mounted sensors described herein can be configured to detect, e.g., a position of a surface (e.g., and aft-facing surface) of the cargo 105 and this information can be used to determine, e.g., whether the cargo 105 is in an end load condition.

The foregoing examples are only some of the ways in which targets can be positioned in the interior cargo area 103 of the trailer 102. In other embodiments, for example, the targets 500-500b can be similarly mounted to the floor of the cargo trailer 102, to the ceiling of the cargo trailer 102, to the cargo 105, etc. Additionally, although the cargo targets 500 described above include passive indicia which must be read or otherwise detected for operation, in other embodiments, rather than passive indicia one or more of the support structures 502 can carry an active device for transmitting information to, e.g., a receiver or transceiver on the loading dock 100 (FIG. 1). Such information can include, for example, information regarding the position of the cargo 105, the contents of the cargo 105, the source of the cargo 105, unloading/storage instructions for the cargo 105, etc. Suitable transmitting devices can include, for example, RF transmitters and other known wireless devices. In some embodiments, the one or more of the sensors 132a-d described above (FIGS. 1 and 2) can be receiving devices (e.g., wireless receivers) configured to receive the wireless communications from the transmitting device in the trailer 102. In some embodiments, the transmitter can be configured such that its signal is blocked when the trailer doors 104 are closed, thereby preventing the corresponding sensor 132 from detecting the signal emitted by the transmitter. However, when the trailer doors 104 are open the signal can be detected by the sensor 132. In such embodiments, the lack of a detected signal when the trailer 102 is present at the loading dock 100 can indicate to the sensor system 130 that the trailer is present but the trailer doors 104 are closed and thus the trailer is not ready for dock operations (e.g., trailer restraint engagement, dock door opening, unloading/loading, etc.). Conversely, the ability to detect the signal from the transmitter can indicate to the sensor system 130 that the trailer doors 104 are appropriately opened and the trailer 102 is ready for dock operations. In yet other embodiments, rather than include machine-readable indicia such as a QR code or barcode, the cargo target 500 can include an optical target such as a reflector, and the sensor 132a and/or the sensors 132b-d can be TOF or similar sensors configured to detect light emitted by the sensor and reflected back to the sensor by the target. Detection of the target 500 in this manner can indicate to the sensor system 130 that the trailer doors 104 are open and thus the trailer 102 is ready for dock operations.

In further embodiments, one or more of the targets 500-500b can be omitted. For example, in some embodiments the targets 500-500b can be omitted and one or more of the sensors 132a-d can configured to detect the presence of physical objects, e.g., the trailer door 104 and/or the cargo 105, when the object is in the sensor's line of sight/field of view. Detecting the presence of the object, e.g., the trailer door 104 (within, e.g., a certain distance or range of distances from the corresponding sensor 132) can be used by the system to determine whether or not the trailer door 104 is open or closed. Similarly, detecting the presence of the trailer cargo 105 (within, e.g., a certain distance or range of distances from the corresponding sensor 132) can be used by the system to determine whether or not the trailer door 104 is open or closed and/or the position of the cargo 105 relative to, e.g., the aft edge of the cargo area 103.

Returning to FIGS. 1 and 2, the sensor system 130 and associated hardware and systems described above can be used in a number of different ways to determine trailer door status and/or cargo status/information and then control the operation of loading dock equipment accordingly. For example, when the trailer 102 approaches the dock station 100, the dock door 110 will typically be in the closed position as shown in FIGS. 1 and 2. With the dock door 110 in this position, the field of view of the sensor 132a includes some or all of the rear of the trailer 102 and/or the interior of the trailer 102 if the trailer doors 104 are open. In those embodiments in which the sensors (e.g., one or more of the sensors 132b-d; FIG. 2) are located adjacent to the dock door, they will also be positioned such that their fields of view will include all or some of the rear of the trailer 102 and the interior of the trailer 102 if the trailer doors 104 are open. In some embodiments, only one of the sensors 132a-d may be utilized to determine the trailer door and/or cargo status/information. In other embodiments, two or more of the sensors 132a-d can be used in combination.

Although the following discussion may refer to the sensor 132a for purposes of illustration, it will be understood that the described technology applies equally to the other sensors 132b-d unless the context clearly requires otherwise. In some embodiments, the sensor 132a is in a powered-down state until the TPS 134a (or the TPS 134b) detects the presence of the trailer 102 at the dock station 100. In other embodiments, a signal indicating that the trailer 102 is present at the dock station 100 can be received from a source other than the TPS 134a or 134b. For example, in some embodiments the presence of the trailer 102 at the dock station 100 can be detected by a yard or logistics management system, the incoming tractor/trailer 102, a dock operator or other dock personnel, and/or other means that provide a signal to the sensor system 130. Once the sensor system 130 receives an indication that the trailer 102 is present at the dock station 100, the sensor 132a is activated and it determines if the trailer door or doors 104 are in an open or closed position as described above. For example, if the sensor 132a detects the presence of the trailer door 104b within a preset distance in front of the sensor, then the sensor 132a can send a corresponding signal to the controller 200 indicating that the trailer doors 104 are closed. Conversely, if the trailer sensor 132a does not detect the presence of the trailer door 104b, then the sensor 132a can send a corresponding signal to the controller 200 indicating that the trailer doors 104 are open. As described in detail below, the controller 200 can be configured to communicate the door status signals it receives from the sensor 132a to, e.g., the dock control panel 202, a dock management system, and/or other dock control system so that subsequent dock operations can be carried out accordingly.

As explained above, in some embodiments the sensors 132a-d can be configured to detect the trailer door (e.g., the trailer door 104b), the trailer cargo 105, and/or one or more of the targets 400 and 500-500b when the aft end of the trailer 102 is positioned in front of the dock opening 108 but spaced apart from the opening 108 (for example, when the trailer 102 is backing up to the dock opening 108), and/or when the aft end of the trailer 102 is positioned directly in front of the dock opening 108 and against, or at least very close to, the dock face (for example, in a position suitable for loading/unloading cargo). For some embodiments in which the sensor 132a is an electro-optical photoelectric sensor, TOF, LIDAR, or other type of sensor/scanner configured to detect the position and/or distance of an object in its field of view (e.g., the trailer door 104b, the cargo 105, etc.) relative to the sensor 132a, it may be important for the sensor system 130 to be configured to detect the object at a preset distance or within a preset range of distances relative to the sensor 132a. More specifically, if the sensor 132a detects an object within its field of view at a particular time, for the sensor system to confirm that the object is, for example, the trailer door 104b, the system would first need to know where the trailer door 104 should be positioned relative to the sensor 132a if the door were closed at that time. Otherwise, the system would not know if the object was the trailer door 104b or, if the door were open, the cargo 105. Similarly, if the sensor 132a detects an object within its field of view at a particular time, for the sensor system to determine that the object is, for example, the trailer cargo 105 (and determine, e.g., the position of the trailer cargo 105 relative to the aft edge of the cargo area 103), the system would first need to know (e.g., within a range of distances) where the trailer cargo 105 should be positioned relative to the sensor 132a at that time. In some embodiments, the sensor system 130 uses information from the TPS 134a (or 134b) to determine when the trailer 102 is within a preset distance, or range, from the sensor 132a. For example, in some embodiments the TPS 134a activates the sensor 132a when the aft trailer wheels 107 roll over the TPS 134a. Since the distance from the aft trailer wheels 107 to the aft end of the trailer 102 where the doors 104 are located (and/or the distance from the aft trailer wheels 107 to the aft edge of the cargo area 103) should be known, and since the distance from the TPS 134a to the sensor 132a should be known, the distance from the aft end of the trailer 102 to the sensor 132a should also be known or at least estimated within a suitable range. As a result, the sensor 132a can be configured to detect objects within a suitable range of the known (or estimated) distance between the aft end of the trailer 102 and the sensor 132a to determine whether the trailer doors 104 are open or closed (and/or to determine, e.g., the position of the trailer cargo 103 relative to the aft edge of the cargo area 103). In some embodiments, for example, the sensor 132a can be configured to detect objects upon activation within a range of from 1 inch to 3 ft., from 1 ft. to 4 ft., from 2 ft. to 6ft., from 4 ft. to 8 ft., from 6 ft. to 10 ft., from 10 ft. to 14 ft., or from 10 ft. to 12 ft. In other embodiments, the sensor 132a can be configured to detect objects within other distances in front of its position. In some embodiments, the sensor system 130 can be configured to delay activation of the sensor 132a until a preset amount of time (e.g., 10-15 seconds) after activation of the TPS 134a and after confirming that the trailer is still present in front of the dock station 100. In such embodiments, the detection range of the sensor 132a can be adjusted for the time delay. Such embodiments may be useful to avoid activating the sensor 132a if the trailer 102 is only backing part of the way toward the loading dock 105 to maneuver or otherwise and then departing from the loading dock 105. In some embodiments, the sensor 132a can be configured to detect the trailer door status when the trailer 102 is parked against (or at least very close to) the dock face as shown in FIG. 1.

Still referring to FIGS. 1 and 2, if the sensor 132a detects that the trailer doors 104 are open, the sensor controller 200 can send a corresponding signal to the dock control panel 202 (and/or a dock management system) which then enables and/or causes additional dock operations to be performed, such as engagement of the trailer restraint 120 with the trailer 102, opening the dock door 110, etc. For example, in some embodiments, the sensor controller 200 can send a signal to the control panel 202 that causes the control panel 202 to display or otherwise provide information to an operator at the control panel 202 indicating that the trailer doors 104 are open. The control panel 202 can also display or otherwise provide information to the operator regarding the status (e.g., the position) of the trailer cargo if it is known at this time. By way of example, the control panel 202 can provide such information to the operator via a textual or graphic message or symbol displayed on, e.g., a screen of the control panel 202, via illumination of an indicator light on the control panel 202 of a certain color, via an audio message, and/or via other known means for conveying information to an operator via the dock control panel 202 and/or an HMI of the control panel 202. In response to the information indicating that the trailer doors 104 are open, the operator can manually activate appropriate dock operations (e.g., engagement of the trailer restraint 120, opening the dock door 110, installation of the dock leveler 116, etc.) via interaction with a touchscreen, keyboard, buttons and/or other HMI of the control panel 202 which is/are operably connected to the corresponding dock equipment. In other embodiments, appropriate dock operations (e.g., engagement of the trailer restraint 120, opening the dock door 110, installation of the dock leveler 116, etc.) can be automatically activated by the control panel 202 and/or the dock management system in response to receiving the signal form the sensor controller 200 indicating that the trailer doors 104 are open. Conversely, if the sensor 132a determines that the trailer doors 104 are closed, it can send a corresponding signal to the dock control panel 202 and/or the dock management system via the controller 200 which in turn prevents or otherwise does not allow the additional dock operations to be performed. Additionally, in some embodiments, in response to receiving such a signal from the sensor controller 200 the dock control panel 202 can display or otherwise provide information to an operator at the control panel 202 indicating that the trailer doors 104 are closed. By way of example, the control panel 202 can provide such information to the operator via a textual or graphic message or symbol displayed on, e.g., a screen of the control panel 202, via illumination of an indicator light on the control panel 202 of a certain color, via an audio message, and/or via other known means for conveying information to an operator via the dock control panel 202 and/or the control panel HMI. The dock operator can respond to this information by, e.g., directing that the trailer 102 be moved away from the dock 100 and the doors 104 opened. If the sensor 132a determines that the trailer doors 104 are closed, the controller 200 may also cause a corresponding signal or message to be sent directly to the dock operator, other dock personnel, and/or the dock management system to indicate that the trailer is not ready for loading/unloading. In some embodiments, personnel may respond to the message by moving the trailer 102 away from the dock 100 and opening the trailer doors 104.

As discussed above, in some embodiments the sensor 132a can be a TOF, radar, or LiDAR ranging sensor or similar type of sensor capable of determining distances between an object in the sensor field of view and the sensor. In such embodiments, if the sensor 132a detects an object (e.g., the trailer door 104b or the cargo 105) that was less than a predetermined distance from the sensor (e.g., the distance required for engagement of the dock leveler lip 118 with the bed of the trailer 102), then the sensor 132a can transmit a corresponding signal to the control panel 202 and/or a dock management system via the controller 200 that causes the control panel 202 to reject the load. Alternatively, the control panel 202 can display or otherwise provide information to an operator at the control panel 202 indicating that the trailer door 104b and/or the cargo 105 is in a position that would preclude engagement of the dock leveler lip 118 with the bed of the trailer 102, and the operator can input instructions to reject the load. Otherwise, if the object was detected at a greater than the predetermined distance, then the signal would signify a “good trailer” and the system would proceed to, e.g., the next steps in an automated unloading/loading process including installing the dock leveler 116 and the associated lip 118 in the trailer 102.

In some embodiments in which the trailer 102 includes both the trailer door target 400 and one or more of the cargo targets 500-500b as discussed above with reference to FIGS. 4-5B, respectively, the door targets 400 can include a first visual pattern and the one or more cargo targets 500-500b can include a second, different visual pattern. For example, the first visual pattern could be a striped yellow/black pattern, while the second visual pattern could be spots or the like. Alternatively, as discussed above, in some embodiments both the target 400 and the one or more targets 500-500b can include a QR code, a barcode, and/or other machine-readable indicia that contain trailer and/or load information, or a combination of machine-readable indicia, visual patterns, and/or symbols.

In some embodiments of automated loading dock systems having one or more of the sensors 132a-d described above, the trailer 102 would approach the dock station 100 and in doing so activate one or both of the TPSs 134a and 134b. This would activate the sensor 132 (e.g., the first sensor 132a) and result in three options: 1) the sensor 132a detects a door target (e.g., the door target 400 of FIG. 4) indicating that the trailer door 104 is closed, 2) the sensor 132a does not detect anything that it can discriminate or otherwise ascertain, indicating that the trailer doors 104 are open (and the cargo load condition is indeterminate), or 3) the sensor 132a detects a cargo target inside the trailer 102 (e.g., one of the cargo targets 500-500b) indicating that the trailer door 104 is open (and that the cargo load condition is normal and not in an end-load condition). In some embodiments, under option 1 the dock system (e.g., the control panel 202) will either reject the trailer 102 and/or communicate with the dock management system that the trailer 102 is not ready for loading/unloading. Under option 2, the system activates an automated dock sequence by, for example, operating the vehicle restraint 120, raising the dock door 110, etc., and ultimately positioning the dock leveler 116 in the trailer 102 but with the lip 118 in the end load position. By end load position it is meant that the cargo 105 in the trailer 102 is at, or may be at, the aft end of the trailer bed so the dock leveler lip 118 is not deployed to extend into the trailer. Additionally, the dock system might also communicate with the dock management system to indicate that the dock leveler 116 (and more specifically, the dock leveler lip 118) is in the end load condition. Under option 3, the system activates the automated dock sequence by operating the vehicle restraint 120, raising the dock door 110, and ultimately placing the dock leveler 116 in the trailer with the dock leveler lip 118 in the standard load/unload position whereby the lip 118 extends into the bed of the trailer 102.

Although portions of the foregoing discussion may refer to the trailer doors 104 as being conventional barn-type doors for purposes of illustration, embodiments of the present technology described herein are not limited to use with any particular type of trailer door unless the context clearly requires otherwise. Accordingly, it will be understood that the present technology can be used with other types of trailer doors including, for example, roll up sectional doors, etc. Also, as noted above, although portions of the foregoing discussion may refer to the sensor 132a for purposes of illustration, it will be understood that the described technology applies equally to the other sensors 132b-d unless the context clearly requires otherwise.

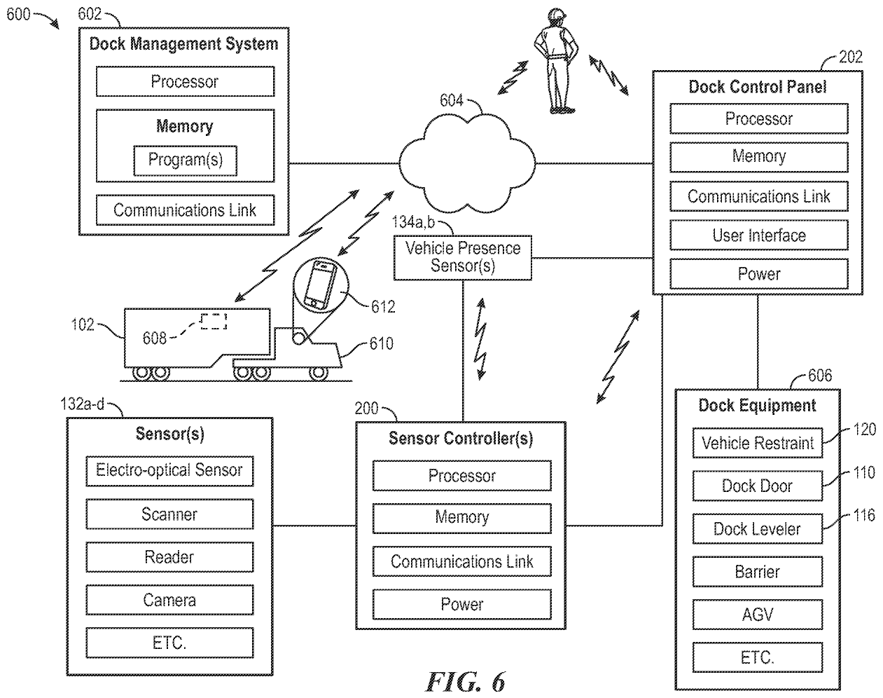

FIG. 6 is a block diagram of a trailer door/trailer cargo detection system 600 configured in accordance with embodiments of the present technology. In the illustrated embodiment, the system 600 can include one or more of the sensors 132a-d, one or more of the corresponding sensor controllers 200, and one or both of the trailer presence sensors 134a and 134b described in detail above with reference to, e.g., FIGS. 1 and 2. Additionally, the system 600 can include the dock control panel 202 which is operably connected to dock equipment 606. The dock equipment 606 can include, for example, the vehicle restraint 120, the dock door 110, the dock leveler 116, as well as other equipment typically found at conventional loading dock stations such as, for example, a dock barrier, automated guided vehicles (AGV), a dock seal, an air curtain, and/or dock lights, etc. In the illustrated embodiment, the dock control panel 202 is operably connected to a dock management system 602 via a communication link 604. In the illustrated embodiment, the trailer 102 and/or a corresponding tractor or truck 610 can include a trailer communication device 608 by which information can be communicated between the trailer 102 and/or the truck 610 to, for example, the dock control panel 102 and/or the dock management system 602 via the communication link 604. Additionally, it will be understood that, in some embodiments, the driver of the truck 116 can also communicate with the dock management system 602 and/or the dock control panel 202 directly and/or via the communication link 604 with, for example, a hand-held device 612 (e.g., a mobile phone), or other suitable wireless communication device.

As will be understood by those of ordinary skill in the art, the sensor controller 200 and the dock control panel 202 can each include an HMI, one or more processors (e.g. a programmable logic controller (PLC)), non-transitory computer-readable media (e.g., memory), and a corresponding communication device suitable for, e.g., wireless (e.g., short range wireless) and/or wired communications, as well as a local power source (e.g., a battery) and/or connections to external power. In some embodiments, the dock management system 602 can be a central dock management system that is operably connected to a plurality of docking stations at a loading dock 100 (FIG. 1), and can include one or more processors, memory storing executable programs (including, in some embodiments, machine learning programs), and a communications link for wired and/or wireless communication with, for example, the corresponding dock control panels located at the various loading dock stations.

While various connection paths and communication links are shown in FIG. 6, in various embodiments, any of the illustrated entities can be directly or indirectly networked to each other wirelessly and/or by various wired connections. In some embodiments the communication link 604, as well as any of the connections between the entities shown in FIG. 6, can include one or more of the Internet, a local area network (LAN), a wide area network (WAN), or other wired or wireless networks. These networks may include the Internet or at least a portion of other public or private networks. The networks can include wireless networks using, e.g., Wi-Fi, cellular, mesh networks (e.g., Zigbee, Z-Wave, Bluetooth, Thread), etc. The networks can be implemented using various standards such as IEEE802.15.4, IEEE802.11x, cellular network technologies, etc. Although the sensor controller 200 and the dock control panel 202 are depicted logically as being separate elements, the functions performed by these devices can be performed, at least partially, in a distributed computing environment encompassing other processing devices located at the loading dock 100 or at remote locations.

Any of the processing devices described herein (e.g., the processor associated with the sensor controller 200, the dock control panel 202, and/or the dock management system 602) can include a processor (e.g., a central processing unit (CPU), a PLC or other type of controller, etc.) and a non-transitory computer-readable storage medium (e.g., memory) that stores computer-executable instructions (e.g., programs for executing the routines described herein) that when executed by the corresponding processor carry out the functions attributed to the various processing devices as described herein. Although not required, aspects and embodiments of the present technology can be described in the general context of computer-executable instructions, such as routines executed by a special-purpose computer, a general-purpose computer, e.g., a server or personal computer, etc.

In some embodiments, the system 600 (e.g., the dock management system 602, the dock control panel 202, and/or other processing devices associated therewith) can utilize machine learning and/or an associated neural network to determine cargo status and/or trailer door status. For example, using an optical, LiDAR, or other sensor system as described herein, the status of the trailer doors (or door) can be determined by comparison of the detected, sensed, imaged, and/or mapped door types, structures, colors and/or other features of a trailer positioned at the dock to a multitude of stored door types, structures, colors, features and/or other options using a learned algorithm. Similarly, the same type of comparison can be utilized to determine the status of trailer cargo if any is present in the trailer, including cargo location (end load, normal load, partial load, empty), type (palleted, stacked, box vs. drum, etc.) and/or density to aid in dock operation efficiency. The algorithm may determine that certain cargo types or combinations of cargo types may be unsuitable for loading/unloading at a particular dock due to equipment limitations, such as type of dock leveler, type of material handling equipment (forklift, AGV, etc.), or other type of equipment available at the dock, or due to other reasons. If the algorithm determines that certain cargo types or combinations of cargo types may be unsuitable for loading/unloading at a particular dock, the system can notify, e.g., a dock operator via the control panel 202. In other instances, the algorithm can be capable of analyzing and/or determining the cargo composition and the associated material handling equipment requirements, and then either communicating with or controlling the required material handling operations. In some embodiments, the system 600 and/or one or more processing devices associated therewith might use either a trained or untrained algorithm type or a combination of algorithm types. In some embodiments, a benefit of using a dock management algorithm is the ability to access cargo trailer types and determine whether the rear underride guard (RIG) is present and, if so, what type it is (e.g., square, round, pentagonal, etc.) and whether the dock is capable of accommodating it. The system can include this determination in making its decision whether to accept or reject the trailer.

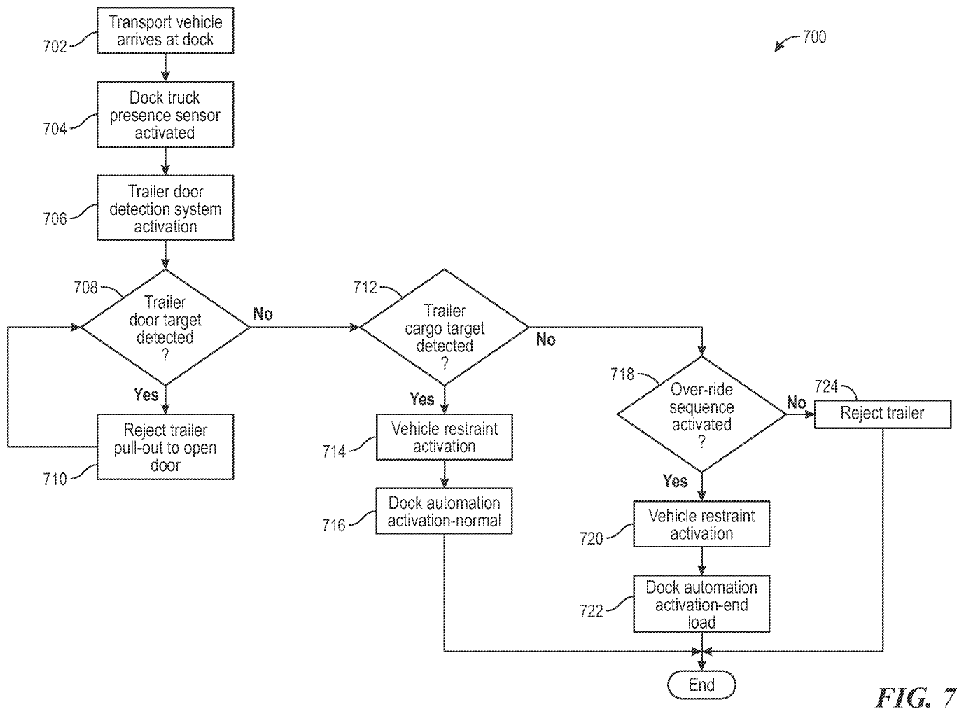

FIG. 7 is a flow diagram of a routine 700 for operating a loading dock trailer door and/or trailer cargo detection system in accordance with embodiments of the present technology. In some embodiments, the routine 700 and portions thereof can be performed by one or more of the processors associated with the dock control panel 202, the sensor control system 200, and/or the dock management system 602 in accordance with computer-executable instructions stored on non-transitory computer-readable media. described above in accordance with computer-executable instructions stored on corresponding non-transitory computer readable media. For purposes of illustration, the routine 700 will be described in the context of the loading dock 100 and associated components and systems described in detail above, but it will be understood that all or portions of the routine 700 can be implemented by other loading docks and loading dock configurations having sensor systems configured in accordance with the present technology.

In block 702, the routine 700 begins when a transport vehicle (e.g., the trailer 102) arrives at the loading dock. In block 704, the TPS 134a,b is activated and sends a corresponding signal to, e.g., the dock control panel 202, which in turn activates the sensor controller 200 and/or one or more of the corresponding sensors 132a-d, as shown in block 706. In decision block 708, the routine determines if the trailer door (e.g., one or more of the trailer doors 104) is detected by the sensor or sensors. For example, in some embodiments, the trailer door 104b can include a target, such as the target 400 described above with reference to FIG. 4. As noted, this target can include, for example, a QR code, a barcode, etc. If the target on the trailer door is detected by the sensor, this indicates that the trailer doors are closed and the routine 700 proceeds to block 710 and the trailer is rejected. In some embodiments, rejecting the trailer can entail sending a signal to a dock operator or other personnel via e.g., the control panel 202, indicating that the trailer doors are closed and that the trailer should be pulled away from the docking station (if additional space is needed to open the trailer doors) and the trailer doors opened, after which the trailer can be backed up to the face of the docking station and the routine continues. Conversely, if the trailer door target is not detected in decision block 708, this indicates that the trailer doors are opened and the routine proceeds to decision block 712 and determines if a trailer cargo target is detected.

In some embodiments, the trailer cargo target can be the same as or similar to the one or more of the cargo targets 500-500b described above with reference to FIGS. 5A and 5B. As discussed with reference to these figures, if the cargo target is detected this can be an indication that the cargo is not in an end load condition, in which case the routine proceeds to block 714 and the vehicle restraint 120 is activated to engage the trailer 102 and restrain the trailer 102 at the docking station. After this step, “normal” automated dock operations can be activated in block 716 and subsequently carried out. For example, in some embodiments, this can include the dock control panel 202 and/or the dock management system 602 sending a series of operational commands to the dock equipment as necessary to unload cargo in a non-end load condition from the trailer 102, and subsequently load new cargo into the trailer. Such operations can include, for example, raising the dock door 110, installing the dock leveler 116 and the corresponding dock leveler lip 118 in the trailer 102, and/or unloading/loading of cargo by personnel and/or AGVs, etc. In some embodiments, if the cargo target is detected, thereby indicating that the cargo is not in an end load condition, the sensor controller 200 can send a corresponding signal to the control panel 202 that causes the control panel 202 to display or otherwise provide information to an operator at the control panel 202 indicating that the cargo is not in an end load condition. By way of example, the control panel 202 can provide such information to the operator via a textual or graphic message or symbol displayed on, e.g., a screen of the control panel 202, via illumination of an indicator light on the control panel 202 of a certain color, via an audio message, and/or via other known means for conveying information to an operator via the dock control panel 202 and/or the HMI of the control panel 202. In some embodiments, in response to the information indicating that the cargo is not in an end load condition, the operator can manually activate appropriate dock operations (e.g., engagement of the trailer restraint 120, raising the dock door 110, installing the dock leveler 116 and the corresponding dock leveler lip 118 in the trailer 102, and/or unloading/loading of cargo by personnel and/or AGVs, etc.) via interaction with a touchscreen, keyboard, buttons and/or other HMI of the control panel 202. In other embodiments, these dock operations can be automatically activated by the control panel 202 and/or the dock management system in response to the information indicating that the cargo is not in an end load condition.

Returning to decision block 712, if the trailer cargo target is not detected, this could be an indication that the trailer cargo is in an end load condition as described above with reference to FIGS. 5A and 5B. As a result, the routine proceeds to decision block 718 to determine if an over-ride sequence has been activated. In some embodiments, the over-ride sequence can be activated by, for example, a dock operator, a remote dock manager, and/or other manual or automated systems. For example, in some embodiments, if the cargo target is not detected, thereby indicating that the cargo could be in an end load condition, the sensor controller 200 can send a corresponding signal to the control panel 202 that causes the control panel 202 to display or otherwise provide information to a dock operator at the control panel 202 indicating that the cargo may be in an end load condition. In response to this information, the operator can manually activate the over-ride sequence via interaction with a touchscreen, keyboard, buttons and/or other HMI of the control panel 202. If the over-ride sequence has been activated, then the routine proceeds to block 720 and activates the vehicle restraint 120. Then the routine proceeds to block 722 and activates automated dock operations for the trailer cargo being in an end load condition. For example, in some embodiments the automated dock procedures utilized for a trailer with cargo in the end load condition can include deploying the dock leveler 116 such that the dock leveler lip 118 is retracted and remains pendant from the distal edge of the dock leveler 116 during trailer unloading and/or loading operations. Returning to decision block 718, if the over-ride sequence is not activated the routine proceeds to block 724 and the trailer is rejected. Such rejection can include, for example, having a dock operator or other personnel manually verify that the trailer cargo is not in an end load condition before proceeding with dock operations. After any of blocks 716, 722 or 724 the routine ends.

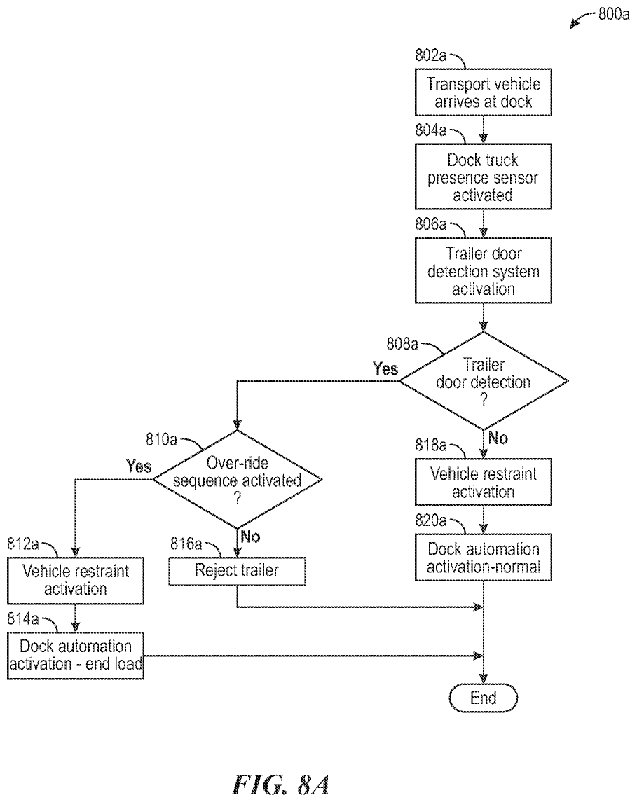

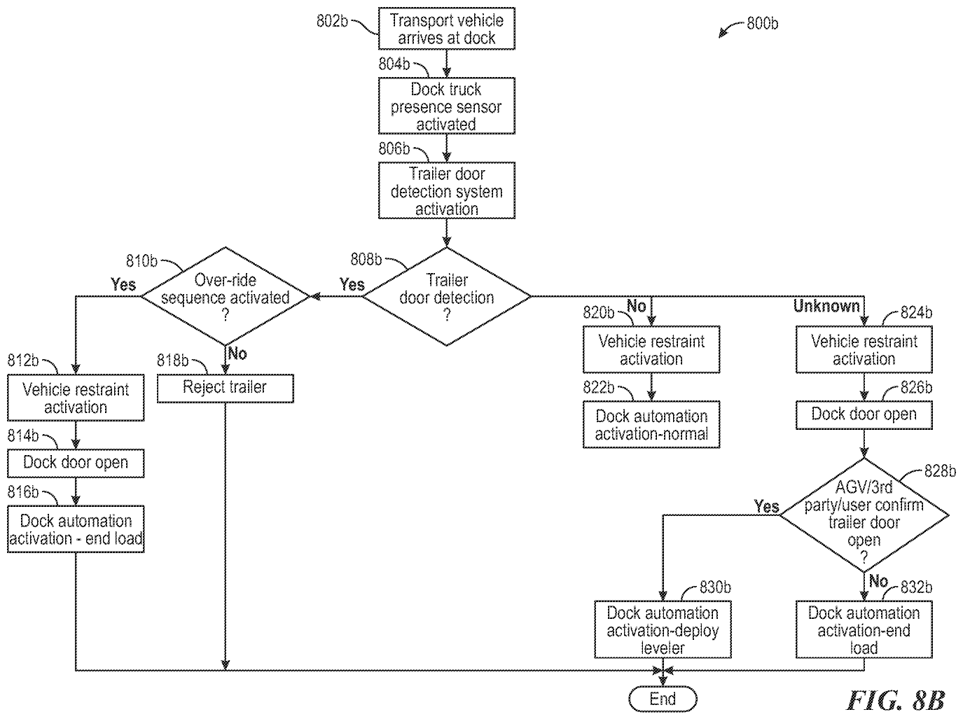

FIGS. 8A and 8B are flow diagrams of routines 800a and 800b, respectively, for operating a trailer door detection system in accordance with embodiments of the present technology. Like the routine 700 described above, in some embodiments the routines 800a and 800b, or portions thereof, can be performed by one or more of the processors associated with the dock controller 202, the sensor controller 200, and/or the dock management system 602 in accordance with computer-executable instructions stored on non-transitory computer-readable media. For purposes of illustration, the routines 800a and 800b may be described below in the context of the loading dock 100 and associated components and systems described in detail above, but it will be understood that all or portions of the routines 800a and 800b can be implemented by other loading docks and loading dock configurations having sensor systems configured in accordance with the present technology.

Referring first to FIG. 8A, the routine 800a begins in block 802a when a transport vehicle (e.g., the trailer 102) arrives at the loading dock. In block 804a, the TPS 134a, b is activated which in turn causes the trailer door detection system to be activated in block 806a. As discussed above, activation of the trailer door detection system can include activating one or more of the sensors 132a-d to determine the trailer door status (open or closed). In decision block 808a, the routine determines if the trailer door has been detected. As discussed above, detection of the trailer door (“yes” in decision block 808a) can indicate that the trailer door or doors 104 are closed, in which case the routine proceeds to decision block 810a to determine if an over-ride sequence has been activated. For example, in some embodiments, a dock operator can receive a signal, message or other indication (via, e.g., the dock control panel 202, the dock management system 602, etc.) that the trailer door has been detected in a closed position. In response to this message, the dock operator can initiate an over-ride sequence by directing the driver to move the trailer away from the dock so that the trailer doors can be opened. After the trailer doors have been opened, the dock operator can direct the driver to back the trailer up to the dock face. Once the trailer is at the dock face the routine proceeds to block 812a and activates the vehicle restraint 120 to engage the trailer 102. (In some embodiments, for example, the dock operator can manually activate the vehicle restraint 120 via the control panel 202. In other embodiments, the vehicle restraint 120 can be automatically activated by, e.g., the control panel 202, the dock management system 602, etc.) However, if the trailer door is a roll up type door, rather than direct the driver to pull away from the dock to open the trailer doors, the dock operator can optionally direct the driver to proceed with backing the trailer up to the dock face, because the roll up trailer door can be manually opened from inside the loading dock after the trailer arrives at the dock face and the dock door has been opened. After block 812a, the routine proceeds to block 814a and activates automated dock operations for the trailer cargo being in an end load condition. Such automated dock operations can include, for example, a sequence of automated dock operations including opening the dock door 110, installing the dock leveler 116 with the lip 118 retracted, deploying AGVs to unload cargo, etc. Returning to decision block 810a, if the over-ride sequence has not been activated, then the routine proceeds to block 816a and the trailer is rejected.

Returning to decision block 808a, if the trailer door is not detected, this indicates that the trailer door or doors are open and the routine proceeds to block 818a and activates the vehicle restraint 120. Next, the routine proceeds to block 820a and activates an automated dock operational sequence for the trailer cargo in a normal (e.g., non-end load) condition. (In some embodiments, for example, the dock operator can manually activate the vehicle restraint 120 and the automated dock operational sequence via the control panel 202. In other embodiments, the vehicle restraint 120 and/or the automated dock operational sequence can be automatically activated by, e.g., the control panel 202, the dock management system 602, etc.) After any of the blocks 814a, 816a and 820a the routine ends.

Referring next to FIG. 8B, the routine 800b begins in block 802b when the transport vehicle arrives at the dock. In block 804b, the TPS sensor is activated, which in turn causes activation of the trailer door detection system in block 806b. In decision block 808b, the routine determines if the trailer door has been detected. If so, this corresponds to the trailer door or doors being in the closed position, and as a result the routine proceeds to decision block 810b to determine if an over-ride sequence has been activated (for example, as described above with reference to block 810a of FIG. 8A). If the over-ride sequence has not been activated, then the routine proceeds to block 818b and rejects the trailer. Conversely, if the over-ride sequence has been activated, then the routine proceeds to block 812b and activates the vehicle restraint 120. This is followed by opening of the dock door 110 in block 814b and activating the sequence of automated dock operations for trailer cargo in an end load condition in block 816b.

Returning to decision block 808b, if the trailer door detection system does not detect the trailer door, the routine proceeds to block 820b and activates the vehicle restraint, followed in block 822b by activation of the automated dock operations for trailer cargo in a normal (e.g., non-end load) condition. Alternatively, if it is unknown whether the trailer doors are in the open or closed position (for example, if the sensor system 130 of FIGS. 1 and 2 cannot confirm the trailer door status), the routine can proceed to block 824b from decision block 808b and activate the vehicle restraint, followed by opening of the dock door in block 826b. After the dock door has been opened, in decision block 828b an AGV (such as an automated forklift) can utilize, e.g., onboard sensor technology (e.g., electro-optical sensors, LiDar scanners, TOF sensors, ultrasonic sensors, etc.) to confirm that the trailer door is open. Alternatively, a dock operator, or other user or third party can visually inspect the aft end of the trailer to confirm that the trailer door is open and manually input this information into the dock control system via, e.g., the dock control panel 202 and/or via a handheld wireless device. If the trailer door is confirmed to be open in decision block 828b, then the routine proceeds to block 830b and activates the automated dock operation sequence, which includes deploying the dock leveler for trailer cargo in a non-end load condition. Conversely, if the routine did not confirm the trailer doors were open in decision block 828b, then the routine proceeds to block 832b and activates the automated dock operation sequence for trailer cargo in an end load condition. After any of blocks 816b, 830b or 832b the routine ends.

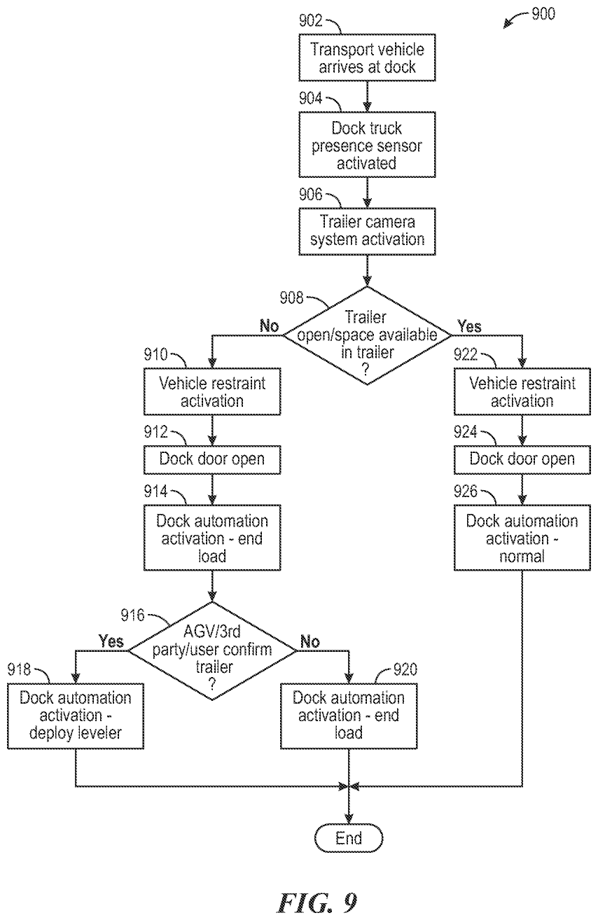

FIG. 9 is a flow diagram of a routine 900 for operating a trailer door/trailer interior space detection system in accordance with embodiments of the present technology. Like the routines described above, in some embodiments the routine 900, or portions thereof, can be performed by one or more of the processors associated with the dock controller 202, the sensor controller 200, and/or the dock management system 602 in accordance with computer-executable instructions stored on non-transitory computer-readable media. In block 902, the routine begins when the transport vehicle (e.g., the trailer 102) arrives at the loading dock, and in block 904 the TPS detects the arrival of the vehicle and is activated. In block 906, a camera system at the loading dock is activated in response to a signal from the TPS. For example, in some embodiments the camera system include one or more sensors 132a-d described above that include a camera or other imaging device for imaging the aft end of the trailer. In other embodiments, the loading dock can include one or more sensors that contain other 3D imaging technology, such as 3D lidar sensors, 3D radar imaging devices, etc. The camera system images the aft end of the trailer, and in decision block 908 the routine determines, based on the images, if the trailer doors are open and/or there is an open space available at the end of the trailer. More specifically, the camera system can determine whether there is sufficient space between the aft edge of the cargo area and the cargo such that the lip of the dock leveler can be installed onto the floor of the cargo area without interference. If not, then the routine proceeds to block 910 and activates the vehicle restraint, followed by opening of the dock door in block 912. In block 914, an automated dock operation sequence is activated for trailer cargo in an end load condition. More specifically, in this embodiment the operation sequence would include installation of the dock leveler but without deployment of the dock leveler lip into the trailer. However, in decision block 916, an AGV, a third party, a dock operator or other user can visually or otherwise confirm that the trailer doors are open and, if so, that there is space at the end of the trailer cargo area for installation of the dock leveler lip. If the trailer doors are open and there is ample space at the end of the trailer, then the routine proceeds to block 918 and the automated dock operational sequence is again activated to deploy the dock leveler in a normal configuration with an extended lip. Conversely, if the trailer doors are closed and they are barn type doors, then the trailer must be disengaged by the restraint and pulled away from the dock so that the doors can be opened and then the trailer must return to the dock. However, if the door is not open but it is a roll up type door, the trailer can remain at the dock station and the door can be opened via the dock door opening. Once the trailer door or doors are open, the routine proceeds to block 920 and activates the automated dock operation sequence for cargo in an end load condition. Returning to decision block 908, if the camera system is able to confirm that the trailer doors are open and there is sufficient open space available at the end of the trailer cargo area for installation of the dock leveler lip, the routine proceeds to block 922 and activates the vehicle restraint, followed by opening of the dock door in block 924 and subsequent activation of the automated dock operation sequence 926 for a normal cargo condition. After any of blocks 918, 920 or 926 the routine ends.

FIGS. 7-9 are representative flow diagrams that depict processes used in some embodiments. These flow diagrams may not show all functions or exchanges of signals and data for all embodiments of the present technology, but instead provide an understanding of steps performed or commands, data, and/or information exchanged under the system. Those of ordinary skill in the art will recognize that some functions and steps may be repeated, varied, omitted, or supplemented, and other (e.g., less important) aspects not shown may be readily implemented. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. In some embodiments, one or more of the steps depicted in FIGS. 7-8B can be of a type well known in the art and can itself include a sequence of operations that need not be described herein. Those of ordinary skill in the art can create source code, microcode, program logic arrays or otherwise implement the present technology based on the flow diagrams and the detailed description provided herein. While some embodiments are shown and described as being implemented in hardware, such embodiments could equally be implemented in software and be performed by one or more processors. Such software can be stored on any suitable non-transitory computer-readable medium, such as microcode stored in a semiconductor chip, on a computer-readable disk, or downloaded from a server and stored locally at a client.

Aspects of the present technology can be embodied in a special purpose computer or data processor that is specifically programmed, configured, or constructed to perform one or more of the computer-executable instructions described in detail herein. While aspects of the present technology, such as certain functions, are described as being performed exclusively on a single device, the present technology can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Although not required, aspects of the present technology are described in the general context of computer-executable instructions, such as routines executed by a general-purpose data processing device, e.g., a server computer, wireless device or personal computer. Those of ordinary skill in the art will appreciate that aspects of the present technology can be practiced with other communications, data processing, or computer system configurations, including: Internet appliances, hand-held devices (including personal digital assistants (PDAs)), wearable computers, all manner of cellular or mobile phones (including Voice over IP (VOIP) phones), dumb terminals, media players, multi-processor systems, microprocessor-based or programmable consumer electronics, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the present technology may be stored or distributed on tangible non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present technology may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). The terms “memory,” “computer-readable storage medium,” and the like include any combination of temporary, persistent, and/or permanent storage, e.g., ROM, writable memory such as RAM, writable non-volatile memory such as flash memory, hard drives, solid state drives, removable media, and so forth, but do not include a propagating signal per se.

The following U.S. Patent and Patent Applications are incorporated by reference herein in their entireties: U.S. Pat. No. 11,262,747, titled VEHICLE IDENTIFICATION AND GUIDANCE SYSTEMS AND ASSOCIATED METHODS; U.S. patent application Ser. No. 17/582,944, titled VEHICLE IDENTIFICATION AND GUIDANCE SYSTEMS AND ASSOCIATED METHODS; U.S. patent application Ser. No. 17/829,057, titled LOADING DOCK AUTOMATED TRAILER DOOR SYSTEMS; U.S. patent application Ser. No. 17/853,729, titled POWERED TRAILER SYSTEMS; and U.S. patent application Ser. No. 18/071,425, titled TRAILER VALIDATION SYSTEMS. Any patents and applications and other references noted herein, including any that may be listed in accompanying filing papers, are incorporated herein by reference in the entirety, except for any subject matter disclaimers or disavowals, and except to the extent that the incorporated material is inconsistent with the express disclosure herein, in which case the language in this disclosure controls. Aspects of the present technology can be modified, if necessary, to employ the systems, functions, and concepts of the various references described above to provide yet further implementations of the present technology.

The following examples are illustrative of several embodiments of the present technology:
1. A loading dock system, comprising:
dock wall having a dock door opening therein;
a dock door operably positioned in the dock door opening; and
one or more sensors—
   wherein the one or more sensors are operably mounted to at least one of the dock door, the dock wall adjacent to the dock door opening, and/or a mounting structure proximate the dock door and/or the dock wall,
   wherein the one or more sensors are configured to detect one or more targets positioned within a cargo trailer located in front of the dock door opening, and
   wherein the one or more sensors are further configured to obtain information related to cargo positioned in the cargo trailer via detection of the one or more targets.
2. The loading dock system of example 1 wherein each of the one or more targets include machine-readable indicia, and wherein each of the one or more sensors includes at least one of a scanner or reader configured to read the machine-readable indicia.
3. The loading dock system of example 2 wherein the machine-readable indicia includes at least one of a QR code or a barcode.
4. The loading dock system of any of examples 1-3 wherein each of the one or more sensors is configured to detect a distance between it and the one or more targets.
5. The loading dock system of example 1 wherein at least one of the one or more sensors is a photoelectric sensor or a time of flight (TOF) sensor configured to detect a distance between the at least one sensor and at least of the one or more targets.
6. The loading dock system of any of examples 1 or 5 wherein each of the one or more targets includes a reflective target, and wherein each of the one or more sensors is configured to emit light that is reflected off at least one of the one or more targets and back to the sensor.
7. The loading dock system of any of examples 1-6 wherein at least one of the one or more targets is positioned on a target support structure mounted to an interior side wall of the cargo trailer.
8. The loading dock system of example 7 wherein the at least one target is positioned on an arm of the target support structure, and wherein the arm is operably movable between a deployed position in which the arm extends away from the side wall and a stowed position in which the arm is retracted toward the side wall.
9. The loading dock system of any of examples 1-8, further comprising:
a vehicle presence sensor, wherein the vehicle presence sensor is configured to detect a presence of the cargo trailer in front of the dock door opening, and wherein the one or more sensors are configured to activate in response to the vehicle presence sensor detecting the presence of the cargo trailer.
10. A loading dock system, comprising:
dock wall having a dock door opening therein;
a dock door operably positioned in the dock door opening;
one or more sensors operably mounted to at least one of the dock door, the dock wall adjacent to the dock door opening, and/or a mounting structure proximate the dock door and/or the dock wall;
at least one piece of loading dock equipment; and
one or more processors operably connected to the at least one piece of loading dock equipment and the one or more sensors—
   wherein the one or more sensors are configured to detect one or more targets positioned within a cargo trailer located in front of the dock door opening,
   wherein the one or more sensors are further configured to transmit information related to the detection of the one or more targets to the one or more processors, and
   wherein the one or more processors are configured to activate the at least one piece of loading dock equipment based on the information from the one or more sensors.
11. The loading dock system of example 10 wherein the information from the one or more sensors is related to a position of cargo in the cargo trailer.
12. The loading dock system of any of examples 10 or 11 wherein the cargo trailer includes a cargo area having an aft edge, and wherein the information from the one or more sensors is related to a position of cargo relative to the aft edge of the cargo area.
13. The loading dock system of any of examples 10-12 wherein the one or more processors are configured to activate an automated dock procedure based on the information provided by the one or more sensors.
14. The loading dock system of any of examples 10-13 wherein the at least one piece of loading dock equipment includes:
a vehicle restraint positioned in front of the dock door opening; and
a dock leveler operably positioned at least partially behind the dock door opening, wherein the one or more processors are configured to activate automatic operation of the vehicle restraint and the dock leveler based on the information provided by the one or more sensors.
15. The loading dock system of any of examples 10-14 wherein the at least one piece of loading dock equipment includes a dock leveler operably positioned at least partially behind the dock door opening, wherein the dock leveler includes a lip operably coupled to a distal edge portion thereof, wherein the lip is movable between an extended position and a retracted position, and wherein—
the one or more processors are configured to deploy the dock leveler with the lip in the retracted position if the information from the one or more sensors indicates that the cargo is in an end load condition, and
the dock control system is further configured to deploy the dock leveler with the lip in the extended position if the information from the one or more sensors indicates that the cargo is not in the end load condition.
16. A method of operating loading dock equipment at a docking station, the method comprising:
positioning a sensor at the docking station;
detecting, by the sensor, a target positioned within a cargo trailer approaching the docking station or at the docking station;
determining information related to cargo in the cargo trailer based on the detection of the target; and
activating the loading dock equipment based on the determined information.
17. The method of example 16 wherein positioning a sensor at the docking station includes mounting a scanner and/or reader in a loading dock door, and wherein detecting, by the sensor, a target includes reading machine-readable indicia on the target.
18. The method of any of examples 15 or 16 wherein determining information related to cargo in the cargo trailer includes determining information related to a position of the cargo in the cargo trailer.
19. The method of any of examples 16-18—
wherein determining information related to cargo in the cargo trailer includes determining whether the cargo is in an end load condition, and
wherein activating the loading dock equipment based on the determined information includes (1) activating a first automated dock operation for unloading the cargo from the trailer if the cargo is in an end-load condition or (2) activating a second automated dock operation for unloading the cargo from the trailer if the cargo is not in an end-load condition.
20. The method of example 19 wherein the first automated dock operation includes deploying a dock leveler with a dock leveler lip in a retracted position, and wherein the second automated dock operation includes deploying the dock leveler with the dock leveler lip in an extending position.
21. A loading dock system, comprising:
dock wall having a dock door opening therein;
a dock door operably positioned in the dock door opening; and
one or more sensors —wherein the one or more sensors are operably mounted to at least one of the dock door, the dock wall adjacent to the dock door opening, and/or a mounting structure proximate the dock door and/or the dock wall, and
wherein the one or more sensors are configured to detect the presence of cargo within a cargo trailer located in front of the dock door opening.
22. The loading dock system of example 21 wherein at least one of the one or more sensors is configured to detect a distance between the at least one sensor and the cargo.
23. The loading dock system of any of examples 21 or 22 wherein at least one of the one or more sensors is a photoelectric sensor or a time of flight (TOF) sensor configured to detect a distance between the at least one sensor and the cargo.
24. The loading dock system of any of examples 21-23, further comprising:
at least one piece of loading dock equipment; and
one or more processors operably connected to the at least one piece of loading dock equipment and the one or more sensors—
   wherein at least one of the one or more sensors is configured to detect a distance between the at least one sensor and the cargo,
   wherein the at least one sensor is further configured to transmit information related to the detected distance to the one or more processors, and
   wherein the one or more processors are configured to activate the at least one piece of loading dock equipment based on the information from the at least one sensor.
25. The loading dock system of example 24 wherein the at least one piece of loading dock equipment is a dock leveler having a lip, and wherein the one or more processors are configured to activate the dock leveler with the lip extended if the information from the at least one sensor indicates that the cargo is not in an end load condition.
26. The loading dock system of any of examples 24 or 25 wherein the at least one piece of loading dock equipment is a dock leveler having a lip, and wherein the one or more processors are configured to activate the dock leveler with the lip retracted if the information from the at least one sensor indicates that the cargo is in an end load condition.
27. The loading dock system of any of examples 21-26 wherein the one or more sensors are further configured to obtain at least one of an image and/or mapping of the cargo, and wherein the loading dock system further comprises:
one or more processors operably connected to the one or more sensors and configured to execute instructions stored on non-transitory computer-readable media, wherein execution of the instructions cause the one or more processors to compare the at least one image or mapping to multiple stored images or mappings to determine at least one of cargo location in the trailer, cargo type, and/or cargo density.
The above detailed description of examples and embodiments of the present technology is not intended to be exhaustive or to limit the present technology to the precise form disclosed above. While specific examples for the present technology are described above for illustrative purposes, various equivalent modifications are possible within the scope of the present technology, as those skilled in the relevant art will recognize. Aspects of the present technology can be modified, if necessary, to employ the systems, functions, and concepts of the various references described above to provide yet further implementations of the present technology.

References throughout the foregoing description to features, advantages, or similar language do not imply that all of the features and advantages that may be realized with the present technology should be or are in any single embodiment of the present technology. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.
As used herein, the use of relative terminology, such as “about”, “generally”, “approximately”, “substantially” and the like refer to the stated value plus or minus ten percent. For example, the use of the term “about 100” refers to a range of from 90 to 110, inclusive. In instances in which the context requires otherwise and/or relative terminology is used in reference to something that does not include, or is not related to, a numerical value, the terms are given their ordinary meaning to one skilled in the art. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above detailed description using the singular or plural number may also include the plural or singular number respectively. The word “or,” in reference to a list of two or more items, covers all of the following interpretations of the word: any of the items in the list, all of the items in the list, and any combination of the items in the list.
The teachings of the present technology provided herein can be applied to other systems, not necessarily the system described above. The elements and acts of the various examples described above can be combined to provide further implementations of the present technology. Some alternative implementations of the present technology may include not only additional elements to those implementations noted above, but also may include fewer elements. Further any specific numbers noted herein are only examples: alternative implementations may employ differing values or ranges.
While the above description describes various embodiments of the present technology and the best mode contemplated, regardless how detailed the above text, the present technology can be practiced in many ways. In general, the terms used in the following claims should not be construed to limit the present technology to the specific examples disclosed in the specification, unless the above Detailed Description section explicitly defines such terms. Accordingly, the actual scope of the present technology encompasses not only the disclosed examples, but also all equivalent ways of practicing or implementing the present technology under the claims. From the foregoing, it will be appreciated that specific embodiments of the present technology have been described herein for purposes of illustration, but that various modifications may be made without deviating from the spirit and scope of the various embodiments of the present technology. Further, while various advantages associated with certain embodiments of the present technology have been described above in the context of those embodiments, other embodiments may also exhibit such advantages, and not all embodiments need necessarily exhibit such advantages to fall within the scope of the present technology. Accordingly, the invention is not limited, except as by the appended claims.
Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A loading dock system, comprising:
dock wall having a dock door opening therein;
a dock door operably positioned in the dock door opening; and
one or more sensors—
wherein the one or more sensors are operably mounted to at least one of the dock door, the dock wall adjacent to the dock door opening, and/or a mounting structure proximate the dock door and/or the dock wall,
wherein the one or more sensors are configured to detect one or more targets positioned within a cargo trailer located in front of the dock door opening, and
wherein the one or more sensors are further configured to obtain information related to cargo positioned in the cargo trailer via detection of the one or more targets.

2. The loading dock system of claim 1 wherein each of the one or more targets include machine-readable indicia, and wherein each of the one or more sensors includes at least one of a scanner or reader configured to read the machine-readable indicia.

3. The loading dock system of claim 2 wherein the machine-readable indicia includes at least one of a QR code or a barcode.

4. The loading dock system of claim 1 wherein each of the one or more sensors is configured to detect a distance between it and the one or more targets.

5. The loading dock system of claim 1 wherein at least one of the one or more sensors is a photoelectric sensor or a time of flight (TOF) sensor configured to detect a distance between the at least one sensor and at least of the one or more targets.

6. The loading dock system of claim 1 wherein each of the one or more targets includes a reflective target, and wherein each of the one or more sensors is configured to emit light that is reflected off at least one of the one or more targets and back to the sensor.

7. The loading dock system of claim 1 wherein at least one of the one or more targets is positioned on a target support structure mounted to an interior side wall of the cargo trailer.

8. The loading dock system of claim 7 wherein the at least one target is positioned on an arm of the target support structure, and wherein the arm is operably movable between a deployed position in which the arm extends away from the side wall and a stowed position in which the arm is retracted toward the side wall.

9. The loading dock system of claim 1, further comprising:
a vehicle presence sensor, wherein the vehicle presence sensor is configured to detect a presence of the cargo trailer in front of the dock door opening, and wherein the one or more sensors are configured to activate in response to the vehicle presence sensor detecting the presence of the cargo trailer.

10. A loading dock system, comprising:
dock wall having a dock door opening therein;
a dock door operably positioned in the dock door opening;
one or more sensors operably mounted to at least one of the dock door, the dock wall adjacent to the dock door opening, and/or a mounting structure proximate the dock door and/or the dock wall;
at least one piece of loading dock equipment; and
one or more processors operably connected to the at least one piece of loading dock equipment and the one or more sensors—
wherein the one or more sensors are configured to detect one or more targets positioned within a cargo trailer located in front of the dock door opening,
wherein the one or more sensors are further configured to transmit information related to the detection of the one or more targets to the one or more processors, and
wherein the one or more processors are configured to activate the at least one piece of loading dock equipment based on the information from the one or more sensors.

11. The loading dock system of claim 10 wherein the information from the one or more sensors is related to a position of cargo in the cargo trailer.

12. The loading dock system of claim 10 wherein the cargo trailer includes a cargo area having an aft edge, and wherein the information from the one or more sensors is related to a position of cargo relative to the aft edge of the cargo area.

13. The loading dock system of claim 10 wherein the one or more processors are configured to activate an automated dock procedure based on the information provided by the one or more sensors.

14. The loading dock system of claim 10 wherein the at least one piece of loading dock equipment includes:
a vehicle restraint positioned in front of the dock door opening; and
a dock leveler operably positioned at least partially behind the dock door opening, wherein the one or more processors are configured to activate automatic operation of the vehicle restraint and the dock leveler based on the information provided by the one or more sensors.

15. The loading dock system of claim 10 wherein the at least one piece of loading dock equipment includes a dock leveler operably positioned at least partially behind the dock door opening, wherein the dock leveler includes a lip operably coupled to a distal edge portion thereof, wherein the lip is movable between an extended position and a retracted position, and wherein —
the one or more processors are configured to deploy the dock leveler with the lip in the retracted position if the information from the one or more sensors indicates that the cargo is in an end load condition, and
the dock control system is further configured to deploy the dock leveler with the lip in the extended position if the information from the one or more sensors indicates that the cargo is not in the end load condition.

16. A method of operating loading dock equipment at a docking station, the method comprising:
positioning a sensor at the docking station;
detecting, by the sensor, a target positioned within a cargo trailer approaching the docking station or at the docking station;
determining information related to cargo in the cargo trailer based on the detection of the target; and
activating the loading dock equipment based on the determined information.

17. The method of claim 16 wherein positioning a sensor at the docking station includes mounting a scanner and/or reader in a loading dock door, and wherein detecting, by the sensor, a target includes reading machine-readable indicia on the target.

18. The method of claim 16 wherein determining information related to cargo in the cargo trailer includes determining information related to a position of the cargo in the cargo trailer.

19. The method of claim 16 —wherein determining information related to cargo in the cargo trailer includes determining whether the cargo is in an end load condition, and
wherein activating the loading dock equipment based on the determined information includes (1) activating a first automated dock operation for unloading the cargo from the trailer if the cargo is in an end-load condition or (2) activating a second automated dock operation for unloading the cargo from the trailer if the cargo is not in an end-load condition.

20. The method of claim 19 wherein the first automated dock operation includes deploying a dock leveler with a dock leveler lip in a retracted position, and wherein the second automated dock operation includes deploying the dock leveler with the dock leveler lip in an extending position.

21. A loading dock system, comprising:
dock wall having a dock door opening therein;
a dock door operably positioned in the dock door opening; and
one or more sensors—
wherein the one or more sensors are operably mounted to at least one of the dock door, the dock wall adjacent to the dock door opening, and/or a mounting structure proximate the dock door and/or the dock wall, and wherein the one or more sensors are configured to detect the presence of
cargo within a cargo trailer located in front of the dock door opening.

22. The loading dock system of claim 21 wherein at least one of the one or more sensors is configured to detect a distance between the at least one sensor and the cargo.

23. The loading dock system of claim 21 wherein at least one of the one or more sensors is a photoelectric sensor or a time of flight (TOF) sensor configured to detect a distance between the at least one sensor and the cargo.

24. The loading dock system of claim 21, further comprising:
at least one piece of loading dock equipment; and
one or more processors operably connected to the at least one piece of loading dock equipment and the one or more sensors—
wherein at least one of the one or more sensors is configured to detect a distance between the at least one sensor and the cargo,
wherein the at least one sensor is further configured to transmit information related to the detected distance to the one or more processors, and
wherein the one or more processors are configured to activate the at least one piece of loading dock equipment based on the information from the at least one sensor.

25. The loading dock system of claim 24 wherein the at least one piece of loading dock equipment is a dock leveler having a lip, and wherein the one or more processors are configured to activate the dock leveler with the lip extended if the information from the at least one sensor indicates that the cargo is not in an end load condition.

26. The loading dock system of claim 24 wherein the at least one piece of loading dock equipment is a dock leveler having a lip, and wherein the one or more processors are configured to activate the dock leveler with the lip retracted if the information from the at least one sensor indicates that the cargo is in an end load condition.

27. The loading dock system of claim 21 wherein the one or more sensors are further configured to obtain at least one of an image and/or mapping of the cargo, and wherein the loading dock system further comprises:
one or more processors operably connected to the one or more sensors and configured to execute instructions stored on non-transitory computer-readable media, wherein execution of the instructions cause the one or more processors to compare the at least one image or mapping to multiple stored images or mappings to determine at least one of cargo location in the trailer, cargo type, and/or cargo density.
